(19) United States
(12) Patent Application Publication
(10) Pub. No.: US 2025/0208527 A1
(43) Pub. Date: Jun. 26, 2025

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: NAO HIGUCHI, Shizuoka (JP); TSUTOMU NISHIDA, Shizuoka (JP); SHUNTARO WATANABE, Kanagawa (JP); TAICHI SATO, Shizuoka (JP); FUMIYUKI HIYAMA, Shizuoka (JP); KENTARO TANAKA, Shizuoka (JP)

(21) Appl. No.: 18/982,982

(22) Filed: Dec. 16, 2024

(30) Foreign Application Priority Data
Dec. 21, 2023 (JP) 2023-216300
Sep. 17, 2024 (JP) 2024-160155
Dec. 4, 2024 (JP) 2024-211674

(51) Int. Cl. G03G 5/087; G03G 5/05

(52) U.S. Cl. CPC G03G 5/087; G03G 5/0575; G03G 2215/00957; G03G 2215/00962; G03G 2221/183

(57) ABSTRACT

An electrophotographic photosensitive member that can resist mass printing. The electrophotographic photosensitive member is an electrophotographic photosensitive member including a surface layer containing a binder resin and inorganic particles. The surface layer contains a urethane resin as the binder resin, wherein the value of the ratio of the volume of the inorganic particles to the volume of the binder resin in the surface layer is 0.10 or more and 3.0 or less. Protrusions derived from the inorganic particles are present on the surface of the surface layer. The inorganic particles to be incorporated into the surface layer have a number-based average primary particle diameter of 10 nm or more and 500 nm or less. The surface of the surface layer has a maximum height roughness Rz of 10 nm or more and 760 nm or less.

### BACKGROUND

### Technical Field

The present disclosure relates to an electrophotographic photosensitive member, and a process cartridge and an electrophotographic apparatus each including the electrophotographic photosensitive member.

### Description of the Related Art

In recent years, in the field of an electrophotographic apparatus, an increase in number of printable sheets of the main body of a copying machine or a cartridge, and an increase in printing speed thereof have been required from the viewpoints of a reduction in maintenance frequency and an improvement in usability. To achieve the increase in number of printable sheets and the increase in printing speed in the electrophotographic apparatus, the lifetime of an electrophotographic photosensitive member needs to be increased by improving the durability of the electrophotographic photosensitive member. To lengthen the lifetime of the electrophotographic photosensitive member, a characteristic contributing to its functionality needs to be stabilized during a time period from its initial use to the end of its long-term use.

An image forming method of an electrophotographic system includes a charging step, an exposing step, a developing step, a transferring step, and a cleaning step. In recent years, there has been an image forming method from which the cleaning step is removed. In the electrophotographic apparatus, the electrophotographic photosensitive member and an abutting member such as an intermediate transfer belt are brought into abutment with each other at an appropriate relative rotation speed.

In a related-art electrophotographic photosensitive member, along with an increase in number of printable sheets, the abrasion of its surface due to rubbing with an abutting member, such as a charging member, a transfer member, or a cleaning member, and the contamination of the surface of the electrophotographic photosensitive member with toner or an external additive become apparent, and hence a surface property such as a dynamic friction coefficient changes. In other words, the surface characteristic of the electrophotographic photosensitive member that has been uniform at the time of its initial use changes to a nonuniform surface characteristic at the time of its long-term use. The electrophotographic photosensitive member that is brought into abutment with each abutting member at an appropriate relative rotation speed has a uniform surface characteristic at the time of the initial use, and hence can maintain stable rotation in a printing step. Accordingly, appropriate electrostatic latent image formation is performed on the surface of the electrophotographic photosensitive member. However, the electrophotographic photosensitive member has a nonuniform surface characteristic at the time of the long-term use, and hence cannot maintain stable rotation in the printing step. Accordingly, inappropriate electrostatic latent image formation is performed on the surface of the electrophotographic photosensitive member. As a result, a horizontal streak image occurs in an image to be output.

The disadvantage is liable to occur in an electrophotographic apparatus that is required to have a lifetime longer than before. In particular, the disadvantage is remarkable at the time of the long-term use of an electrophotographic apparatus that is required to have a printing speed higher than before. A method of solving the disadvantage is, for example, the following electrophotographic photosensitive member: a change in surface characteristic during a time period from initial use to the end of long-term use is suppressed by suppressing the abrasion of the surface of the electrophotographic photosensitive member. To achieve such solving method, for example, the following technologies have been proposed.

In Japanese Patent Application Laid-Open No. 2014-174426, there is a proposal of the following technology: a surface layer in an electrophotographic photosensitive member is formed from a urethane resin and an inorganic filler, and its ten-point average surface roughness (Rz value) is controlled to improve the durability of the electrophotographic photosensitive member.

In Japanese Patent Application Laid-Open No. 2001-201874, there is a proposal of the following technology: a step of charging an electrophotographic photosensitive member is changed from a general charging method based on discharge to an injection charging system that does not involve the discharge to suppress the deterioration of the electrophotographic photosensitive member due to the discharge; and a urethane resin is used in the protective layer of the electrophotographic photosensitive member to improve the durability of the electrophotographic photosensitive member.

However, at the time of long-term use in an electrophotographic apparatus having a larger number of printable sheets and a higher printing speed than before, in Japanese Patent Application Laid-Open No. 2014-174426, the inorganic filler introduced into the surface layer of the electrophotographic photosensitive member has locally desorbed from the surface layer to preclude the maintenance of a uniform surface characteristic. Stable rotation cannot be maintained in a printing step during a time period from the initial stage of printing to the later stage of the printing, and hence inappropriate electrostatic latent image formation is performed at the time of the long-term use. As a result, a horizontal streak image has occurred in an image to be output.

In Japanese Patent Application Laid-Open No. 2001-201874, stable abutment between the electrophotographic photosensitive member and a charging member cannot be maintained owing to an increase in printing speed, and hence it has been impossible to secure uniform charging in the charging step. As a result, density unevenness has occurred in an image to be output.

### SUMMARY

The present disclosure provides an electrophotographic photosensitive member that suppresses a horizontal streak image occurring at the time of its long-term use in an electrophotographic apparatus having a larger number of printable sheets and a higher printing speed than before.

The above-mentioned aspect is achieved by the present disclosure described below. That is, an electrophotographic photosensitive member according to the present disclosure is an electrophotographic photosensitive member including a surface layer containing a binder resin and inorganic particles, wherein the surface layer contains a urethane resin as the binder resin, wherein a value of a ratio of a volume of the inorganic particles to a volume of the binder resin in the surface layer is 0.10 or more and 3.0 or less, wherein protrusions derived from the inorganic particles are present on a surface of the surface layer, wherein the inorganic particles to be incorporated into the surface layer have a number-based average primary particle diameter of 10 nm or more and 500 nm or less, and wherein the surface of the surface layer has a maximum height roughness Rz of 10 nm or more and 760 nm or less.

The present disclosure is also directed to a process cartridge including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable onto a main body of an electrophotographic apparatus.

The present disclosure is also directed to an electrophotographic apparatus including: the above-mentioned electrophotographic photosensitive member; and a charging unit, an exposing unit, a developing unit, and a transfer unit.

Further features of the present disclosure will become apparent from the following description of exemplary embodiments with reference to the attached drawings.

### BRIEF DESCRIPTION OF THE DRAWINGS

FIG. 1 is an illustration of an example of the layer configuration of an electrophotographic photosensitive member according to the present disclosure.

FIG. 2 is a view for illustrating an example of the schematic configuration of an electrophotographic apparatus including a process cartridge including the electrophotographic photosensitive member and a charging unit.

### DESCRIPTION OF THE EMBODIMENTS

An exemplary embodiment of the present disclosure is described below.

### [Electrophotographic Photosensitive Member]

An electrophotographic photosensitive member of the present disclosure includes a support, and a charge-generating layer, a charge-transporting layer, and a surface layer containing particles, the layers being arranged on the support. Although the electrophotographic photosensitive member according to the present disclosure may be used as a cylindrical electrophotographic photosensitive member obtained by forming the charge-generating layer, the charge-transporting layer, and the surface layer on a cylindrical support, a belt shape or a sheet shape is permitted.

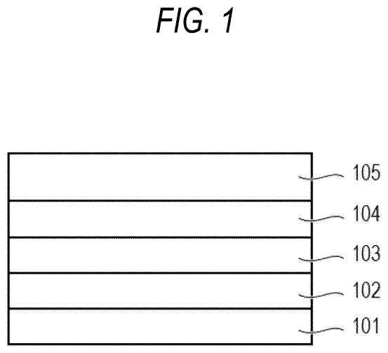

FIG. 1 is a view for illustrating an example of the layer configuration of the electrophotographic photosensitive member. In FIG. 1, a support is represented by reference symbol 101, an undercoat layer is represented by reference symbol 102, a charge-generating layer is represented by reference symbol 103, and a charge-transporting layer is represented by reference symbol 104. The surface layer according to the present disclosure is represented by reference symbol 105.

The electrophotographic photosensitive member of the present disclosure may be used in an image forming method including: a charging step of charging the surface of the electrophotographic photosensitive member; an exposing step of exposing the charged electrophotographic photosensitive member to form an electrostatic latent image; a developing step of supplying toner to the electrophotographic photosensitive member having formed thereon the electrostatic latent image to form a toner image; a transferring step of transferring the toner image formed on the electrophotographic photosensitive member; and a cleaning step of removing the toner remaining on the electrophotographic photosensitive member in the transferring step.

In addition, the electrophotographic photosensitive member of the present disclosure may be used in such an image forming method that the cleaning step is omitted from the image forming method in addition to the image forming method.

As a method of producing the electrophotographic photosensitive member of the present disclosure, there is given a method including preparing coating liquids for the respective layers to be described later, applying the liquids in a desired order of layers, and drying the liquids. In this case, examples of a method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

The present disclosure is directed to an electrophotographic photosensitive member including a surface layer containing a binder resin and inorganic particles, the electrophotographic photosensitive member satisfying the following: the surface layer contains a urethane resin as the binder resin; a value of a ratio of a volume of the inorganic particles to a volume of the binder resin in the surface layer is 0.10 or more and 3.0 or less; protrusions derived from the inorganic particles are present on a surface of the surface layer; the inorganic particles to be incorporated into the surface layer have a number-based average primary particle diameter of 10 nm or more and 500 nm or less; and the surface of the surface layer has a maximum height roughness Rz of 10 nm or more and 760 nm or less.

The above-mentioned configuration can achieve the suppression of a horizontal streak image occurring at the time of its long-term use in an electrophotographic apparatus having a larger number of printable sheets and a higher printing speed than before. Although the mechanism via which the disadvantage is solved by the configuration of the present disclosure has not been elucidated, the inventors of the present disclosure have assumed the mechanism to be as described below.

A horizontal streak occurring at the time of the long-term use in the electrophotographic apparatus having a larger number of printable sheets and a higher printing speed than before is affected by a change in surface characteristic of the electrophotographic photosensitive member. The change in surface characteristic of the electrophotographic photosensitive member is mainly caused by the following two causes.

A first cause is the abrasion of the surface of the electrophotographic photosensitive member. Along with mass printing, the electrophotographic photosensitive member is rubbed with an abutting member such as a cleaning member for a long time period. Thus, a surface shape designed through use of, for example, treatment to which the surface of the electrophotographic photosensitive member has been subjected or particles is broken, and hence the surface shape that has originally been uniformly designed gradually changes to a nonuniform surface state with increasing number of printable sheets. Thus, the dynamic friction coefficient and tackiness of the surface of the electrophotographic photosensitive member are no longer uniform.

A second cause is the contamination of the surface of the electrophotographic photosensitive member with toner or the like. The number of opportunities for the surface of the electrophotographic photosensitive member to be brought into contact with a contaminant, such as the toner, an external additive, or paper powder, is increased by mass printing. Thus, the surface of the electrophotographic photosensitive member is contaminated, and hence its surface state gradually changes with increasing number of printable sheets. Thus, the dynamic friction coefficient and tackiness of the surface of the electrophotographic photosensitive member change.

To suppress the above-mentioned change in surface characteristic of the electrophotographic photosensitive member, the following methods are available.

That is, the suppression of the abrasion of the surface of the electrophotographic photosensitive member and an improvement in resistance thereof against contamination with toner or the like are available. Alternatively, the design of the initial surface characteristic of the electrophotographic photosensitive member, which is considered so that a change in surface characteristic thereof may not be nonuniform even when the abrasion or the contamination occurs, is available.

In the present disclosure, in the surface layer of the electrophotographic photosensitive member, the urethane resin excellent in durability is used, and the ratio of the volume of the inorganic particles to the volume of the binder resin is set to 0.10 or more and 3.0 or less. Thus, the protrusions derived from the inorganic particles are formed on the surface of the surface layer to achieve a reduction in contact area between the electrophotographic photosensitive member and the abutting member. Further, a reduction in tackiness of the electrophotographic photosensitive member is achieved by designing a contact portion between the electrophotographic photosensitive member and the abutting member so that the portion may be a protrusion derived not from the urethane resin having viscosity but from the inorganic particles. Thus, a reduction in dynamic friction coefficient thereof is achieved. When the ratio of the volume of the inorganic particles to the volume of the binder resin is less than 0.10, the protrusions derived from the inorganic particles cannot be formed on the surface of the surface layer, and hence the contact area with the abutting member cannot be reduced. Thus, the abrasion of the surface layer at the time of the long-term use of the electrophotographic photosensitive member cannot be suppressed, and hence the surface characteristic thereof becomes nonuniform to cause an image failure. In addition, when the ratio of the volume of the inorganic particles to the volume of the binder resin is more than 3.0, the ratio of the binder resin having a role of binding the inorganic particles to the surface layer reduces, and hence a function of binding the inorganic particles to the surface layer weakens. Accordingly, at the time of the long-term use, the desorption of the inorganic particles from the surface layer occurs to cause the abrasion of the surface layer. As a result, an image failure occurs.

In addition, the sizes of the protrusions derived from the inorganic particles to be formed on the surface of the surface layer of the electrophotographic photosensitive member are controlled by setting the number-based average primary particle diameter of the inorganic particles to be incorporated into the surface layer to 10 nm or more and 500 nm or less. Thus, the maximum height roughness Rz of the surface of the surface layer becomes 10 nm or more and 760 nm or less, and hence many fine protrusions derived from the inorganic particles are formed. When the number of the protrusions derived from the inorganic particles to be brought into contact with the abutting member is increased, a load to be applied to each of the protrusions is dispersed, and hence the loads to the protrusions are suppressed. Accordingly, the desorption of the particles from the surface layer is suppressed. Thus, the surface characteristic of the electrophotographic photosensitive member can be prevented from becoming nonuniform at the time of its long-term use. When the maximum height roughness Rz of the surface of the surface layer is less than 10 nm, a surface except the protrusions derived from the inorganic particles is brought into contact with the abutting member, and hence a reduction in contact area between the layer and the member by the protrusions cannot be achieved. In addition, contact between the binder resin and the abutting member occurs, and hence the tackiness of the electrophotographic photosensitive member cannot be reduced. As a result of the foregoing, an increase in dynamic friction coefficient thereof and the abrasion of the surface layer are liable to occur, and hence an image failure occurs at the time of the long-term use. In addition, when the maximum height roughness Rz of the surface of the surface layer is more than 760 nm, the protrusions derived from the inorganic particles are liable to desorb, and hence an image failure occurs at the time of the long-term use.

In addition, the maximum height roughness Rz of the surface layer is preferably set to 40 nm or more and 760 nm or less, and is more preferably set to 600 nm or less. Thus, an abutting pressure from the abutting member to be applied to the protrusions derived from the inorganic particles can be controlled, and hence a surface shape excellent in durability can be maintained while the desorption of the inorganic particles from the surface layer is suppressed.

Further, the average length Rsm of the roughness curve elements of the surface layer is preferably set to 20 nm or more and 1,400 nm or less. Thus, an interval between the protrusions derived from the inorganic particles can be designed to be an interval excellent in durability. Further, the average length Rsm of the roughness curve elements of the surface layer is preferably set to 25 nm or more and 200 nm or less, and is more preferably set to 25 nm or more and 180 nm or less. When the Rsm falls within the ranges, the number of the protrusions derived from the inorganic particles to be formed per unit area is controlled, and hence a load to be applied to each of the protrusions is reduced. Accordingly, the desorption of the inorganic particles from the surface layer can be suppressed. When the average length Rsm of the roughness curve elements of the surface layer is less than 20 nm, the interval between the protrusions derived from the inorganic particles narrows to increase their points of contact with the abutting member, and hence the effect of point contact reduces. In addition, when the average length Rsm of the roughness curve elements of the surface layer is more than 1,400 nm, the interval between the protrusions derived from the inorganic particles widens, and hence a pressure applied from the abutting member to each of the protrusions increases. Accordingly, the desorption of the protrusions derived from the inorganic particles is liable to occur.

In addition, the arithmetic average roughness Ra of the surface layer is preferably set to 10 nm or more and 500 nm or less. Thus, there can be designed a surface shape in which the desorption of the protrusions derived from the inorganic particles is suppressed while a reduction in contact area between the electrophotographic photosensitive member and the abutting member is achieved. Further, the arithmetic average roughness Ra is preferably set to 10 nm or more and 320 nm or less, and is more preferably set to 12 nm or more and 200 nm or less. When the Ra falls within the ranges, such control that many fine protrusions derived from the inorganic particles are formed on the surface of the surface layer is performed. Thus, a load to be applied to each of the protrusions is reduced, and hence the desorption of the inorganic particles from the surface layer can be suppressed. When the arithmetic average roughness Ra of the surface layer is less than 10 nm, the region of the surface layer except the protrusions is liable to be brought into contact with the abutting member, and hence the contact area does not reduce. In addition, when the arithmetic average roughness Ra of the surface layer is more than 500 nm, a pressure applied from the abutting member to each of the protrusions increases, and hence the desorption of the protrusions derived from the inorganic particles is liable to occur.

Further, the dynamic friction coefficient of the surface layer in an environment at 25° C. and 50% RH is preferably set to 0.95 or less. Thus, abrasion between the abutting member and the surface layer is suppressed, and hence the layer can resist long-term use. Further, the dynamic friction coefficient of the surface layer is preferably set to 0.90 or less, and is more preferably set to 0.85 or less. When the coefficient falls within the ranges, loads to be applied to the protrusions derived from the inorganic particles, the protrusions being formed on the surface of the surface layer, can be suppressed, and hence the desorption of the inorganic particles from the surface layer can be reduced. When the dynamic friction coefficient of the surface layer is more than 0.95, the abrasion between the abutting member and the surface layer occurs to cause an image failure at the time of the long-term use.

Further, the inorganic particles to be incorporated into the surface layer each preferably have a functional group having reactivity with an isocyanate group. Thus, at the time of the curing of the urethane resin, the resin and the inorganic particles react to be bonded to each other, and hence the inorganic particles can be strongly held on the surface layer. Examples of the functional group having reactivity with an isocyanate group include a hydroxy group and an amino group. Examples of the inorganic particles include silica particles and metal oxide particles.

In addition, the arithmetic average thickness of the surface layer is preferably 2.0 μm or less. Thus, the number of the inorganic particles embedded in the surface layer can be reduced, and as a result, the protrusions derived from the particles are easily formed on the surface of the surface layer. The thickness of the surface layer may be controlled by the resin solid content of a coating liquid for the surface layer and the coating rate thereof at the time of its impregnation coating. As the resin solid content becomes lower, the thickness reduces, and as the coating rate becomes lower, the thickness easily reduces.

In addition, the Mohs hardness of each of the inorganic particles to be incorporated into the surface layer is preferably set to 4.0 or more. Further, the hardness is preferably set to 7.0 or more, and is more preferably set to 9.0 or more. When the hardness falls within the ranges, the abrasion of the inorganic particles due to rubbing between the protrusions derived from the inorganic particles, the protrusions being formed on the surface of the surface layer, and the abutting member can be suppressed, and hence the surface shape of the layer can be maintained even in the later stage of printing.

Further, the inorganic particles to be incorporated into the surface layer are preferably silica particles or metal oxide particles. Thus, the particles themselves are hardly abraded, and hence the surface shape can be maintained even in the later stage of the printing. When the Mohs hardness of each of the inorganic particles to be incorporated into the surface layer is less than 4.0, the protrusions derived from the inorganic particles are abraded at the time of the long-term use of the electrophotographic photosensitive member, and hence the protrusions are lost. As a result, an image failure occurs.

In addition, the urethane resin to be incorporated into the surface layer preferably has a nurate structure. Thus, the abrasion resistance of the resin itself is improved, and hence the surface shape can be maintained even in the later stage of the printing.

Further, the urethane resin to be incorporated into the surface layer is preferably a polymer of an isocyanate compound having three or more polymerizable functional groups and a polyol compound. Thus, a resin having formed therein a three-dimensional structure is synthesized, and hence a resin that is tough and excellent in abrasion resistance is obtained. Such resin can contribute to the maintenance of the surface shape in the later stage of the printing.

In addition, the urethane resin to be incorporated into the surface layer is preferably a polymer of an isocyanate compound having a nurate structure and a polyol compound. Thus, the nurate structure is easily introduced into the structure of the urethane resin, and hence the abrasion resistance of the urethane resin is improved. Accordingly, the surface shape can be maintained even in the later stage of the printing.

Further, the urethane resin to be incorporated into the surface layer is preferably a polymer of an isocyanate compound and a polyol having an average molecular weight of 2.0×10³ or less. Thus, the viscosity of the urethane resin can be suppressed, and hence the dynamic friction coefficient of the surface layer can be set to a low value.

In addition, the metal oxide particles to be incorporated into the surface layer are each preferably niobium atom-doped titanium oxide. The volume resistivity of the surface layer of the electrophotographic photosensitive member needs to be controlled to an appropriate value. The value is a value that changes in accordance with the configuration of an image forming apparatus. When the volume resistivity of the surface layer of the electrophotographic photosensitive member is excessively low, a latent image cannot be maintained, and hence an image blur occurs. In contrast, when the volume resistivity of the surface layer is high, a ghost image occurs owing to an influence of residual electricity. The volume resistivity of the surface layer is changed by abrasion or contamination, and when the volume resistivity is changed to the volume resistivity at which an image blur or a ghost image is caused by the long-term use of the image forming apparatus, an image failure occurs. In other words, the volume resistivity of the surface layer needs to be controlled to an appropriate value. The volume resistivity of the surface layer depends on the volume resistivity of a metal oxide to be incorporated, and hence when the metal oxide is incorporated into the surface layer, a metal oxide having a suitable volume resistivity needs to be selected. The volume resistivity of the niobium atom-doped titanium oxide can be controlled by its niobium content. In other words, the volume resistivity of the surface layer can be finely controlled by the niobium content without any change in content of the metal oxide. Accordingly, even when electroconductive particles are used, a surface layer suitable for the electrophotographic photosensitive member can be formed.

The above-mentioned mechanism is based on an assumption, and the assumption does not affect the technical scope of the present disclosure.

### <Binder Resin>

The binder resin according to the present disclosure is, for example, a urethane resin. In addition, the surface layer of the present disclosure may be formed as a cured film by polymerizing a composition containing a monomer having a polymerizable functional group. A reaction at that time is, for example, a thermal polymerization reaction, a polymerization reaction utilizing moisture in air, or a polymerization reaction in which a main agent and a curing agent are mixed. Examples of the polymerizable functional group of the urethane resin include a hydroxyl group and an isocyanate group. Examples of the hydroxyl group include a hydroxy group, a carboxyl group, and a phenol group. A compound having a hydroxyl group to be used in the polymerization reaction of the urethane resin is, for example, a polyol. In the present disclosure, the kind of the polyol is not particularly limited, and may be appropriately selected in accordance with purposes. However, a polyol having an average molecular weight of 2.0×10³ or less is preferred. Examples of the polyol include a polycaprolactone diol, a polycaprolactone triol, a polycaprolactone tetraol, a lactone-modified polyether polyol, a lactone-modified (meth)acrylate, a carbonate-modified (meth)acrylate, and a polycarbonate diol. Those polyols may be used alone or in combination thereof.

A compound having an isocyanate group to be used in the polymerization reaction of the urethane resin is, for example, hexamethylene diisocyanate (HDI), diphenylmethane diisocyanate (MDI), toluene diisocyanate (TDI), isophorone diisocyanate (IPDI), xylene diisocyanate, trimethylhexamethylene diisocyanate, a HDI biuret form, or a HDI trimethylolpropane adduct form.

A main method of introducing a nurate structure into the urethane resin is, for example, a method including producing a nurate structure at the time of the polymerization reaction or a method including using an isocyanate compound having a nurate structure in the polymerization reaction. When a nurate structure is produced at the time of the polymerization reaction, a catalyst that promotes a trimerization reaction is generally used. Examples of the catalyst include a potassium salt and a quaternary ammonium salt. The isocyanate compound having a nurate structure is, for example, an isocyanurate-type trimer. Examples thereof include a HDI isocyanurate form and an IPDI isocyanurate form. Those trimers may be used alone or in combination thereof. The method of introducing a nurate structure in the urethane resin of the present disclosure is preferably the method including using the isocyanate compound having a nurate structure in the polymerization reaction. This is because in the method including producing a nurate structure at the time of the polymerization reaction, the catalyst is used, and hence concern is raised about the contamination of the abutting member with a catalyst component. A nurate structure contributes as a rigid crosslinking point to the polymerization reaction, and hence the reaction becomes a dense polymerization reaction. Accordingly, in the present disclosure, a reduction in abrasion resistance of the surface layer of the electrophotographic photosensitive member and the exudation of a low-molecular weight component can be prevented.

In addition, the isocyanate group of the isocyanate compound may be a blocked isocyanate blocked with a blocking agent. A free isocyanate group is liable to react. Accordingly, when the coating liquid for the surface layer is prepared, and is then left to stand at normal temperature for a long time period, the reaction may gradually advance to change the characteristics of the coating liquid. The blocked isocyanate is used for preventing the foregoing. This is because the blocking agent does not react until being heated to its dissociation temperature or more. Thus, it becomes easier to handle the coating liquid. Examples of the blocking agent include: phenols, such as cresol and phenol; lactams such as F-caprolactam; and oximes such as methyl ethyl ketoxime. In the present disclosure, a blocking agent that dissociates at from about 100° C. to about 130° C. is preferred because the agent is used in the electrophotographic photosensitive member in which a pigment or the like is used. Such agent is, for example, dimethylpyrazole.

### <Inorganic Particles>

Examples of the inorganic particles to be used in the present disclosure include silica particles, metal oxide particles, and metal particles. The inorganic particles, which are hardly shaved, have low elasticity, and are advantageous in terms of the promotion of point contact with the abutting member, are preferably used as the particles of the surface layer of the electrophotographic photosensitive member of the present disclosure.

The Mohs hardness of each of the inorganic particles to be used in the present disclosure is preferably 4.0 or more. Thus, the abrasion of the inorganic particles due to the rubbing between the protrusions derived from the inorganic particles, the protrusions being formed on the surface of the surface layer, and the abutting member can be suppressed, and hence the surface shape of the layer can be maintained even in the later stage of the printing. Examples of the inorganic particles each having a Mohs hardness of 4.0 or more include particles of magnesium oxide, glass, iron, iron oxide, silicon, titanium oxide, zirconium oxide, and alumina. Those particles may be used alone or in combination thereof.

When the inorganic particles are used, silica particles out of the particles are preferred. The silica particles are expected to exhibit the following effect because the particles have an average circularity larger than those of the other inorganic particles: the particles promote the point contact between the toner and the photosensitive member to alleviate the adhesive force of the toner.

Known silica fine particles may be used as the silica particles, and fine particles of dry silica and fine particles of wet silica may each be used. Of those, fine particles of wet silica obtained by a sol-gel method (hereinafter also referred to as “sol-gel silica”) are preferred.

The sol-gel silica used as the particles to be incorporated into the surface layer of the electrophotographic photosensitive member of the present disclosure may be hydrophilic, or its surface may be subjected to hydrophobic treatment.

A method for the hydrophobic treatment is, for example, a method including removing a solvent from a silica sol suspension in the sol-gel method to dry the suspension, and then treating the dried product with a hydrophobic treatment agent, or a method including directly adding the hydrophobic treatment agent to the silica sol suspension to dry and treat the suspension simultaneously. Of those, an approach including directly adding the hydrophobic treatment agent to the silica sol suspension is preferred from the viewpoints of the control of the half-width of the particle size distribution of the sol-gel silica and the control of the saturated moisture adsorption amount thereof.

Examples of the hydrophobic treatment agent include the following:
chlorosilanes, such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane;
silazanes, such as hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane;
silicone oils, such as a dimethyl silicone oil, a methyl hydrogen silicone oil, a methyl phenyl silicone oil, an alkyl-modified silicone oil, a chloroalkyl-modified silicone oil, a chlorophenyl-modified silicone oil, a fatty acid-modified silicone oil, a polyether-modified silicone oil, an alkoxy-modified silicone oil, a carbinol-modified silicone oil, an amino-modified silicone oil, a fluorine-modified silicone oil, and an end reactive silicone oil;
siloxanes, such as hexamethylcyclotrisiloxane, octamethylcyclotetrasiloxane, decamethylcyclopentasiloxane, hexamethyldisiloxane, and octamethyltrisiloxane; and
as fatty acids and metal salts thereof, long-chain fatty acids, such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, and arachidonic acid, and salts of those fatty acids and metals, such as zinc, iron, magnesium, aluminum, calcium, sodium, and lithium.

Of those, alkoxysilanes, silazanes, and silicone oils are each preferably used because the hydrophobic treatment is easily performed. Those hydrophobic treatment agents may be used alone or in combination thereof.

### <Niobium Atom-Doped Titanium Oxide>

The volume resistivity of the niobium atom-doped titanium oxide to be used in the present disclosure only needs to be adjusted to a volume resistivity suitable for an image forming apparatus to be used by controlling its niobium content. Specifically, the niobium content only needs to be adjusted to 0.5 mass % or more and 15.0 mass % or less. In addition, the niobium atom-doped titanium oxide may have an oxygen defect. When the oxygen defect is present, the volume resistivity reduces. An oxygen defect ratio is preferably 2.0% or less when the oxide is used in the surface layer of the electrophotographic photosensitive member. When the oxygen defect ratio is more than 2.0%, the particles of the oxide become blackish to reduce the optical transparency of the surface layer. The reduction leads to a reduction in sensitivity of the electrophotographic photosensitive member. The oxygen defect may be introduced into the titanium oxide through firing under a reducing atmosphere, such as ammonia or hydrogen, or firing together with organic matter under a nitrogen atmosphere at not less than 600° C. that is the decomposition temperature of the organic matter. The physical properties of the niobium atom-doped titanium oxide, such as a particle diameter and a volume resistivity, may be controlled by adjusting the kind of core particles to be used, and a niobium atom-to-titanium atom weight ratio in a titanium-niobium mixed liquid with respect to a core.

### <Additive>

The surface layer in the present disclosure may contain an additive, such as a catalyst for a polymerization reaction, an antioxidant, a UV absorber, a plasticizer, a leveling agent, a slipperiness-imparting agent, or an abrasion resistance-improving agent. Specific examples thereof include a quaternary ammonium salt, a hindered phenol compound, a hindered amine compound, a sulfur compound, a phosphorus compound, a benzophenone compound, a siloxane-modified resin, and a silicone oil.

### <Solvent>

A solvent in which the binder resin, the inorganic particles, and the additive are stably dispersed or dissolved only needs to be appropriately selected. Specific examples thereof include: alcohols, such as methanol, ethanol, isopropanol, butanol, and octanol; ketones, such as acetone and cyclohexanone; esters, such as ethyl acetate, butyl acetate, ethyl lactate, γ-butyrolactone, propylene glycol monomethyl ether acetate, and propylene glycol monoethyl ether acetate; ethers, such as ethylene glycol monomethyl ether and diethylene glycol monobutyl ether; aromatic hydrocarbons, such as benzene, toluene, and xylene; and amides, such as dimethylformamide, dimethylacetamide, and N-methylpyrrolidone.

In addition, a plurality of solvents may be used in combination for adjusting the drying rate of the film of a curable composition and adjusting the viscosity of the curable composition to a viscosity suitable for application.

### <Surface Layer>

The surface layer may be formed by: preparing a coating liquid for a surface layer containing the above-mentioned respective materials and a solvent; forming a coat of the liquid; and drying and/or curing the coat. In impregnation coating, the roughness of the surface layer may be adjusted by its drying temperature after the coating, the kind of the solvent, and the solid content of the coating liquid. For example, when a solvent species having a high volatilization rate is used, the convection of the liquid at the time of the drying becomes faster, and hence the roughness shows an increasing tendency. By the same reason, even when the drying temperature after the coating is increased, the roughness shows an increasing tendency. When the solid content of the coating liquid is increased, the convection is suppressed, and hence the roughness shows a reducing tendency. In addition, when the thickness of the surface layer is reduced, the inorganic particles are easily exposed to its surface, and hence the roughness shows an increasing tendency. The thickness may be reduced by reducing the coating rate of the coating liquid at the time of the impregnation coating or by reducing the solid content of the coating liquid.

### <Support>

In the present disclosure, the electrophotographic photosensitive member preferably includes a support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support. Examples of the metal include aluminum, iron, nickel, copper, gold, stainless steel, and alloys thereof Δn aluminum support using aluminum out of those metals is preferred.

In addition, electroconductivity may be imparted to the resin or the glass through treatment involving, for example, mixing or coating with an electroconductive material.

### <Electroconductive Layer>

In the present disclosure, an electroconductive layer may be arranged on the support. The arrangement of the electroconductive layer can conceal flaws and unevenness in the surface of the support, and control the reflection of light on the surface of the support. The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminate configuration obtained by covering a pre-covering particle made of, for example, titanium oxide, barium sulfate, or zinc oxide with a metal oxide different from the particle in composition. The covering is performed with, for example, a metal oxide such as tin oxide.

In addition, when the metal oxide is used as the electroconductive particles, their average primary particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, resin particles, or a concealing agent such as titanium oxide.

The electroconductive layer has an average thickness of preferably 1 μm or more and 50 μm or less, particularly preferably 3 μm or more and 40 μm or less.

The electroconductive layer may be formed by: preparing a coating liquid for an electroconductive layer containing the above-mentioned respective materials and a solvent; forming a coat of the liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method including using a paint shaker, a sand mill, a ball mill, or a liquid collision-type high-speed disperser.

### <Undercoat Layer>

In the present disclosure, an undercoat layer may be arranged on the support or the electroconductive layer.

The undercoat layer has an average thickness of preferably 0.1 μm or more and 50 μm or less, more preferably 0.2 μm or more and 40 μm or less, particularly preferably 0.3 μm or more and 30 μm or less.

A resin for the undercoat layer is, for example, a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamic acid resin, a polyurethane resin, a polyimide resin, a polyamideimide resin, a polyvinylphenol resin, a melamine resin, a phenol resin, an epoxy resin, and an alkyd resin.

A resin having a structure in which a resin having a polymerizable functional group and a monomer having a polymerizable functional group are crosslinked with each other is also permitted.

In addition, the undercoat layer may contain an inorganic compound or an organic compound in addition to the resin.

Examples of the inorganic compound include a metal, an oxide, and a salt.

Examples of the metal include gold, silver, and aluminum. Examples of the oxide include zinc oxide, white lead, aluminum oxide, indium oxide, silicon oxide, zirconium oxide, tin oxide, titanium oxide, magnesium oxide, antimony oxide, bismuth oxide, indium oxide, tin oxide, and zirconium oxide. Examples of the salt include barium sulfate and strontium titanate.

Those inorganic compounds may each be present under a particle state in a film serving as the undercoat layer.

The number-average particle diameter of the particles of the inorganic compound is preferably 1 nm or more and 500 nm or less, more preferably 3 nm or more and 400 nm or less.

Those inorganic compounds may each have a laminated configuration including a core particle and a covering layer covering the particle.

The surfaces of those inorganic compounds may each be treated with, for example, a silicone oil, a silane compound, a silane coupling agent, or any other organosilicon compound, or an organotitanium compound. In addition, those inorganic compounds may each be doped with an element, such as tin, phosphorus, aluminum, or niobium.

Examples of the organic compound include an electron-transporting compound and an electroconductive polymer.

Examples of the electroconductive polymer include polythiophene, polyaniline, polyacetylene, polyphenylene, and polyethylenedioxythiophene.

Examples of the electron-transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound.

The electron-transporting material may have a polymerizable functional group and may be crosslinked with a resin having a functional group reactive with the functional group. Examples of the polymerizable functional group include a hydroxy group, a thiol group, an amino group, a carboxyl group, a vinyl group, an acryloyl group, a methacryloyl group, and an epoxy group.

Those organic compounds may each be present under a particle state in the film, or their surfaces may be treated.

Various additives including a leveling agent such as a silicone oil, a plasticizer, and a thickener may be added to the undercoat layer.

The undercoat layer is obtained by: preparing a coating liquid for an undercoat layer containing the above-mentioned materials; then applying the liquid onto the support or the electroconductive layer; and then drying or curing the coat.

A solvent at the time of the production of the coating liquid is, for example, an alcohol-based solvent, a ketone-based solvent, an ether-based solvent, an ester-based solvent, or an aromatic hydrocarbon-based solvent.

A dispersion method for dispersing the particles of the materials in the coating liquid is, for example, a method including using a paint shaker, a sand mill, a ball mill, or a liquid collision-type high-speed disperser.

### <Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer is a photosensitive layer having a charge-generating layer containing a charge-generating material and a charge-transporting layer containing a charge-transporting material. (2) The monolayer-type photosensitive layer is a photosensitive layer containing both a charge-generating material and a charge-transporting material.

### (1) Laminate-Type Photosensitive Layer

The laminate-type photosensitive layer has the charge-generating layer and the charge-transporting layer.

### (1-1) Charge-Generating Layer

The charge-generating layer preferably contains the charge-generating material and a resin.

Examples of the charge-generating material include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating material in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by: preparing a coating liquid for a charge-generating layer containing the above-mentioned respective materials and a solvent; forming a coat of the liquid on the undercoat layer; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

The charge-generating layer has a thickness of preferably 0.1 μm or more and 1.5 μm or less, more preferably 0.15 μm or more and 1.0 μm or less.

### (1-2) Charge-Transporting Layer

The charge-transporting layer preferably contains the charge-transporting material and a resin.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

The content of the charge-transporting material in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting material and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The charge-transporting layer may be formed by: preparing a coating liquid for a charge-transporting layer containing the above-mentioned respective materials and a solvent; forming a coat of the liquid on the charge-generating layer; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The charge-transporting layer has a thickness of 3 μm or more and 50 μm or less, more preferably 5 μm or more and 40 μm or less, particularly preferably 10 μm or more and 30 μm or less.

### (2) Monolayer-Type Photosensitive Layer

The monolayer-type photosensitive layer may be formed by: preparing a coating liquid for a photosensitive layer containing the charge-generating material, the charge-transporting material, a resin, and a solvent; forming a coat of the liquid on the undercoat layer; and drying the coat. Examples of the charge-generating material, the charge-transporting material, and the resin are the same as those of the materials in the section “(1) Laminate-type Photosensitive Layer.”

The monolayer-type photosensitive layer has a thickness of preferably 10 m or more and 45 μm or less, more preferably 25 μm or more and 35 μm or less.

### <Process Cartridge and Electrophotographic Apparatus>

The electrophotographic photosensitive member that has been described above may be included in a process cartridge integrally supporting at least one unit selected from the group consisting of: a charging unit; a developing unit; and a cleaning unit. The process cartridge is characterized in that the cartridge is detachably attachable onto the main body of an electrophotographic apparatus.

### (Configuration of Electrophotographic Apparatus)

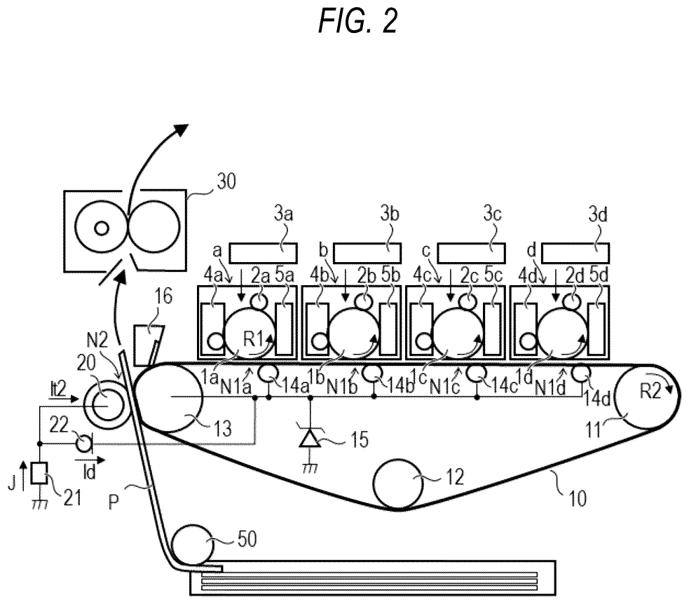

An example of the schematic configuration of an electrophotographic apparatus including a process cartridge including the electrophotographic photosensitive member of the present disclosure is illustrated in FIG. 2.

An electrophotographic apparatus of this embodiment is a so-called tandem-type electrophotographic apparatus provided with a plurality of image forming portions “a” to “d”. A first image forming portion “a” forms an image with yellow toner (Y). A second image forming portion “b” forms an image with magenta toner (M). A third image forming portion “c” forms an image with cyan toner (C). A fourth image forming portion “d” forms an image with black toner (Bk). Those four image forming portions are arranged in a row at constant intervals, and the configurations of the respective image forming portions are substantially the same in many respects except the color of the toner to be stored. Thus, the electrophotographic apparatus of this embodiment is described below through use of the first image forming portion “a”.

The first image forming portion “a” includes a photosensitive drum 1a, which is a drum-shaped photosensitive member, a charging roller 2a, which is a charging member, a developing unit 4a, and a drum cleaning unit 5a.

The photosensitive drum 1a is an image-bearing member that bears a toner image, and is rotationally driven in a direction indicated by the arrow R1 illustrated in the figure at a predetermined peripheral speed (process speed). The developing unit 4a stores yellow toner and develops the yellow toner on the photosensitive drum 1a. The drum cleaning unit 5a is a unit for recovering the toner adhering to the photosensitive drum 1a. The drum cleaning unit 5a includes: a cleaning blade brought into contact with the photosensitive drum 1a; and a waste toner box that stores, for example, the toner removed from the photosensitive drum 1a by the cleaning blade.

An image forming operation is started when a control unit (not shown) such as a controller receives an image signal, and the photosensitive drum 1a is rotationally driven. During the rotation process, the photosensitive drum 1a is uniformly charged to a predetermined voltage (charging voltage) with predetermined polarity (negative polarity in this embodiment) by the charging roller 2a, and is exposed by an exposing unit 3a in accordance with the image signal. Thus, an electrostatic latent image corresponding to a yellow color component image of a target color image is formed on the photosensitive drum 1a. Then, the electrostatic latent image is developed by the developing unit 4a at a developing position and visualized as a yellow toner image on the photosensitive drum 1a. In this case, the normal charging polarity of the toner stored in the developing unit 4a is negative polarity, and the electrostatic latent image is subjected to reversal development with the toner charged to the same polarity as the charging polarity of the photosensitive drum 1a by the charging roller 2a. However, the invention is not limited thereto, and the present disclosure may be applied also to an electrophotographic apparatus in which an electrostatic latent image is subjected to normal development with a toner charged to polarity opposite to the charging polarity of the photosensitive drum 1a.

An endless and movable intermediate transfer belt 10 has electroconductivity, is brought into contact with the photosensitive drum 1a to form a primary transfer portion N1a, and is rotated at substantially the same peripheral speed as that of the photosensitive drum 1a. In addition, the intermediate transfer belt 10 is tensioned by a counter roller 13 serving as a counter member, a drive roller 11 and a tension roller 12 each serving as a tension member, and a metal roller 14a, and is tensioned by the tension roller 12 under a tension of a total pressure of 60 N. The intermediate transfer belt 10 can be moved when the drive roller 11 is rotationally driven in a direction indicated by the arrow R2 illustrated in the figure. In addition, the respective metal rollers 14 and the counter roller 13 are connected to a ground through a Zener diode 15 serving as a constant-voltage element.

The yellow toner image formed on the photosensitive drum 1a is primarily transferred from the photosensitive drum 1a to the intermediate transfer belt 10 in the process of passing through the primary transfer portion N1a. Primary transfer residual toner remaining on the surface of the photosensitive drum 1a is cleaned off and removed by the drum cleaning unit 5a, and is then subjected to an image forming process after charging.

During the primary transfer, a current is supplied to the electroconductive intermediate transfer belt 10 from a secondary transfer roller 20 serving as a secondary transfer member to be brought into contact with the outer peripheral surface of the intermediate transfer belt 10. When the current supplied from the secondary transfer roller 20 flows in the peripheral direction of the intermediate transfer belt 10, the toner image is primarily transferred from the photosensitive drum 1a to the intermediate transfer belt 10. In this case, a voltage J having predetermined polarity (positive polarity in this embodiment) opposite to the normal charging polarity of the toner is applied to the secondary transfer roller 20 from a transfer power source 21. The second, third, and fourth image forming portions in FIG. 2 include photosensitive drums 1b, 1c, and 1d, charging rollers 2b, 2c, and 2d, exposing units 3b, 3c, and 3d, developing units 4b, 4c, and 4d, drum cleaning units 5b, 5c, and 5d, metal rollers 14b, 14c, and 14d, and primary transfer portions N1b, N1c, and N1d, respectively.

Subsequently, a magenta toner image of the second color, a cyan toner image of the third color, and a black toner image of the fourth color are formed in the same manner, and are sequentially transferred onto the intermediate transfer belt 10 so as to be superimposed on one another. Thus, toner images of four colors corresponding to target color images are formed on the intermediate transfer belt 10. After that, the toner images of the four colors borne on the intermediate transfer belt 10 are secondarily transferred in a batch onto the surface of a transfer material P, such as paper or an OHP sheet, fed by a sheet feeding unit 50 in the process of passing through a secondary transfer portion N2 formed by the contact between the secondary transfer roller 20 and the intermediate transfer belt 10. The transfer material P having the toner images of the four colors transferred thereto by the secondary transfer is then heated and pressurized in a fixing unit 30, and thus the toners of the four colors are melted and mixed to be fixed to the transfer material P. The toner remaining on the intermediate transfer belt 10 after the secondary transfer is cleaned and removed by a belt cleaning unit 16 arranged so as to face the counter roller 13 through intermediation of the intermediate transfer belt 10. In addition, a path, which does not pass through the secondary transfer roller 20, and in which the transfer power source 21 and the respective metal rollers 14 are electrically connected to each other through a constant-current diode 22 serving as a constant-current element, is arranged. In addition, at the time of the application of the voltage from the transfer power source 21 to the secondary transfer roller 20, a pinch-off current 1d flows through the constant-current diode 22 separately from a current It2 flowing toward the secondary transfer portion N2.

The electrophotographic photosensitive member of the present disclosure may be used in, for example, a laser beam printer, an LED printer, or a copying machine.

According to the present disclosure, in the design of the surface layer of the electrophotographic photosensitive member, the urethane resin excellent in durability and the inorganic particles are used to produce an appropriate surface state in the surface layer. Thus, there can be provided the electrophotographic photosensitive member that suppresses a horizontal streak image occurring at the time of its long-term use in an electrophotographic apparatus having a larger number of printable sheets and a higher printing speed than before.

### EXAMPLES

The present disclosure is described in more detail below by way of Examples and Comparative Examples. The invention is by no means limited to Examples described below without departing from the gist of the present disclosure.

In the following description of Examples, “part(s)” is by mass unless otherwise specified. In addition, the thickness of each of the layers of electrophotographic photosensitive members of Examples and Comparative Examples was determined with an eddy current-type thickness meter (product name: Fischerscope, manufacturer: Fischer Instruments K.K.), or was determined by converting the mass of the layer per unit area into a specific gravity.

### Production Example of Electrophotographic Photosensitive Member 1

An aluminum cylinder having a diameter of 20 mm and a length of 257.5 mm (standard: JIS-A3003 aluminum alloy) was used as a support (electroconductive support).

An electroconductive layer, an undercoat layer, a charge-generating layer, a charge-transporting layer, and a surface layer were produced by the following methods.

### <Preparation of Coating Liquid for Electroconductive Layer>

Anatase-type titanium oxide having an average primary particle diameter of 200 nm was used as a substrate, and a sulfuric acid solution of titanium and niobium containing 33.7 parts of titanium atoms in terms of TiO₂ and 2.9 parts of niobium atoms in terms of Nb₂O₅ was prepared. 100 Parts of the substrate was dispersed in pure water to provide 1,000 parts of a suspension, and the suspension was warmed to 60° C. The sulfuric acid solution of titanium and niobium, and 10 mol/L sodium hydroxide were dropped over 3 hours so that the pH of the suspension became from 2 to 3. After the dropping of the total amounts of the solutions, the pH was adjusted to the vicinity of a neutral value, and a polyacrylamide-based aggregating agent was added to precipitate a solid content. The supernatant was removed, and the residue was filtered and washed, followed by drying at 110° C. Thus, an intermediate containing 0.1 wt % of organic matter derived from the aggregating agent in terms of C was obtained. The intermediate was fired in nitrogen at 750° C. for 1 hour, and was then fired in air at 450° C. to produce titanium oxide particles 1. The average primary particle diameter of the resultant particles measured by a method of measuring a particle diameter with a scanning electron microscope to be described later was 220 nm.

Subsequently, 50 parts of a phenol resin (monomer/oligomer of a phenol resin) (product name: PLYOPHEN J-325, manufacturer: DIC Corporation, resin solid content: 60%, density after curing: 1.3 g/cm³) serving as a binding material was dissolved in 35 parts of 1-methoxy-2-propanol serving as a solvent to provide a solution.

60 Parts of the titanium oxide particles 1 were added to the solution, and the mixture was loaded into a vertical sand mill using 120 parts of glass beads having a number-average primary particle diameter of 1.0 mm as a dispersion medium. After that, the mixture was subjected to dispersion treatment for 4 hours under the conditions of a dispersion liquid temperature of 23° C.±3° C. and a number of revolutions of 1,500 rpm (peripheral speed: 5.5 m/s). Thus, a dispersion liquid was obtained. The glass beads were removed from the dispersion liquid with a mesh. 0.01 Part of a silicone oil (product name: SH28 PAINT ADDITIVE, manufacturer: Dow Corning Toray Co., Ltd.) serving as a leveling agent and 8 parts of silicone resin particles (product name: KMP-590, manufacturer: Shin-Etsu Chemical Co., Ltd., average primary particle diameter: 2 μm, density: 1.3 g/cm³) serving as a surface roughness-imparting material were added to the dispersion liquid after the removal of the glass beads, and the mixture was stirred. After that, the mixture was filtered with PTFE filter paper (product name: PF-060, manufacturer: Advantec Toyo Kaisha, Ltd.) under pressure to prepare a coating liquid for an electroconductive layer.

### <Preparation of Coating Liquid for Undercoat Layer>

100 Parts of rutile-type titanium oxide particles (average primary particle diameter: 50 nm, manufacturer: Tayca Corporation) were stirred and mixed with 500 parts of toluene, and 3.5 parts of vinyltrimethoxysilane (product name: KBM-1003, manufacturer: Shin-Etsu Chemical Co., Ltd.) was added to the mixture, followed by dispersion treatment in a vertical sand mill using glass beads each having a diameter of 1.0 mm for 8 hours. After the glass beads had been removed, toluene was evaporated by distillation under reduced pressure, and the residue was dried for 3 hours at 120° C. to provide rutile-type titanium oxide particles whose surfaces had already been treated with an organosilicon compound. When the volume of the resultant titanium oxide particles was represented by “a”, and the average primary particle diameter of the titanium oxide particles was represented by “b” [μm], the ratio “a/b” was 15.6. The value of the “a” was determined from a microscopic image obtained by observing a section of an electrophotographic photosensitive member with a field emission scanning electron microscope (FE-SEM, product name: 5-4800, manufacturer: Hitachi High-Technologies Corporation) after the production of the electrophotographic photosensitive member.

18.0 Parts of the rutile-type titanium oxide particles whose surfaces had already been treated with the organosilicon compound, 4.5 parts ofN-methoxymethylated nylon (product name: TORESIN EF-30T, manufacturer: Nagase ChemteX Corporation), and 1.5 parts of a copolymerized nylon resin (product name: AMILAN CM8000, manufacturer: Toray Industries, Inc.) were added to a mixed solvent of 90 parts of methanol and 60 parts of 1-butanol to prepare a dispersion liquid.

The dispersion liquid was subjected to dispersion treatment in a vertical sand mill using glass beads each having a diameter of 1.0 mm for 5 hours, and the glass beads were removed. Thus, a coating liquid for an undercoat layer was prepared.

### <Synthesis of Phthalocyanine Pigment>

### Synthesis Example

Under a nitrogen flow atmosphere, 100 g of gallium trichloride and 291 g of orthophthalonitrile were added to 1,000 mL of α-chloronaphthalene, and the mixture was subjected to a reaction at a temperature of 200° C. for 24 hours, followed by the filtration of the product. The resultant wet cake was stirred in N,N-dimethylformamide under heating at a temperature of 150° C. for 30 minutes, and was then filtered. The resultant filter residue was washed with methanol, and was then dried to provide a chlorogallium phthalocyanine pigment in a yield of 83%.

20 Grams of the chlorogallium phthalocyanine pigment obtained by the above-mentioned method was dissolved in 500 mL of concentrated sulfuric acid, and the solution was stirred for 2 hours. After that, the solution was dropped into a mixed solution of 1,700 mL of distilled water and 660 mL of concentrated ammonia water, which had been cooled with ice, so that the pigment was reprecipitated. The precipitate was sufficiently washed with distilled water, and was dried to provide a hydroxygallium phthalocyanine pigment.

<Preparation of Coating Liquid for Charge-Generating Layer>0.5 Part of the hydroxygallium phthalocyanine pigment obtained in Synthesis Example, 7.5 parts of N,N-dimethylformamide (product code: D0722, manufacturer: Tokyo Chemical Industry Co., Ltd.), and 29 parts of glass beads each having a diameter of 0.9 mm were subjected to milling treatment with a sand mill (product name: BSG-20, manufacturer: AIMEX Co., Ltd.) under a temperature of 25° C. for 24 hours. At this time, the treatment was performed under such a condition that the disc of the sand mill rotated 1,500 times in 1 minute. The liquid thus treated was filtered with a filter (product number: N-NO. 125T, pore diameter: 133 μm, manufacturer: NBC Meshtec Inc.) so that the glass beads were removed. 30 Parts of N,N-dimethylformamide was added to the liquid, and then the mixture was filtered, followed by sufficient washing of the filter residue on a filter with n-butyl acetate. Then, the washed filter residue was dried in a vacuum to provide 0.45 part of a hydroxygallium phthalocyanine pigment. The resultant pigment contained N,N-dimethylformamide.

Subsequently, 20 parts of the hydroxygallium phthalocyanine pigment obtained by the milling treatment, 10 parts of polyvinyl butyral (product name: S-LEC BX-1, manufacturer: Sekisui Chemical Co., Ltd.), 190 parts of cyclohexanone, and 482 parts of glass beads each having a diameter of 0.9 mm were subjected to dispersion treatment with a sand mill (product name: K-800, manufacturer: Igarashi Machine Production Co., Ltd. (currently AIMEX Co., Ltd.), disc diameter: 70 mm, number of discs: 5) under a cooling water temperature of 18° C. for 4 hours. At this time, the treatment was performed under such a condition that the discs each rotated 1,800 times in 1 minute. The glass beads were removed from the dispersion liquid, and 444 parts of cyclohexanone and 634 parts of ethyl acetate were added to the residue to prepare a coating liquid for a charge-generating layer.

### <Preparation of Coating Liquid for Charge-Transporting Layer>

### Production Example of Charge-Transporting Layer

Next, the following materials were prepared to produce a mixed solvent.

| | |
|---|---|
| Orthoxylene | 25 parts by mass |
| Methyl benzoate | 25 parts by mass |
| Dimethoxymethane | 25 parts by mass |

Further, the following materials were dissolved in the mixed solvent to prepare a coating liquid for a charge-transporting layer.

| | |
|---|---|
| Charge-transporting material (hole-transportable material) | 5 parts by |
| represented by the following structural formula (C-1) | mass |
| Charge-transporting material (hole-transportable material) | 5 parts by |
| represented by the following structural formula (C-2) | mass |
| Polycarbonate (product name: IUPILON | 10 parts by |
| Z-400, manufacturer: | mass |
| Mitsubishi Engineering-Plastics Corporation) | |

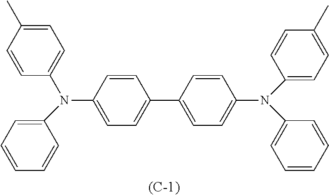 [SMILES: Cc1ccc(N(c2ccccc2)c2ccc(-c3ccc(N(c4ccccc4)c4ccc(C)cc4)cc3)cc2)cc1 ; "(C-1)"]

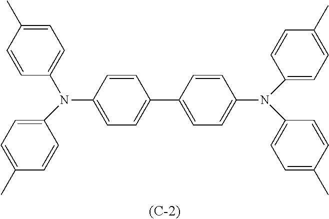 [SMILES: Cc1ccc(N(c2ccc(C)cc2)c2ccc(-c3ccc(N(c4ccc(C)cc4)c4ccc(C)cc4)cc3)cc2)cc1 ; "(C-2)"]

### Production Example of Electrophotographic Photosensitive Member 1

### <Support>

An aluminum cylinder having a diameter of 20 mm and a length of 257.5 mm (standard: JIS-A3003, aluminum alloy) was used as a support (electroconductive support).

### <Electroconductive Layer>

The coating liquid for an electroconductive layer was applied onto the above-mentioned support by dip coating to form a coat, and the coat was heated at 150° C. for 30 minutes to be cured. Thus, an electroconductive layer having a thickness of 22 μm was formed.

### <Undercoat Layer>

The coating liquid for an undercoat layer was applied onto the above-mentioned electroconductive layer by dip coating to form a coat, and the coat was heated at 100° C. for 10 minutes to be cured. Thus, an undercoat layer having a thickness of 1.8 μm was formed.

### <Charge-Generating Layer>

The coating liquid for a charge-generating layer was applied onto the above-mentioned undercoat layer by dip coating to form a coat, and the coat was dried by heating at a temperature of 100° C. for 10 minutes. Thus, a charge-generating layer having a thickness of 0.20 μm was formed.

### <Charge-Transporting Layer>

The coating liquid for a charge-transporting layer was applied onto the above-mentioned charge-generating layer by dip coating to form a coat, and the coat was dried by heating at a temperature of 120° C. for 30 minutes. Thus, a charge-transporting layer having a thickness of 21 μm was formed.

### <Surface Layer>

| | |
|---|---|
| Polyol (product name: PLACCEL DC2016, | 17.83 parts by mass |
| manufacturer: Daicel Chemical Industries, Ltd.) | |
| Isocyanate (product name: BI 7951, manufacturer: | 22.17 parts by mass |
| GSI Creos Corporation) | |
| Inorganic particles (product name: QSG-170, | 17.37 parts by mass |
| manufacturer: Shin-Etsu Chemical Co., Ltd., | |
| silica particles) | |
| Cyclohexane | 100 parts by mass |
| 1-Propanol | 100 parts by mass |
| Additive (product name: US-270, manufacturer: | 5.38 parts by mass |
| Toagosei Co., Ltd.) | |

The above-mentioned materials were mixed and stirred to prepare a coating liquid 1 for a surface layer.

The coating liquid 1 for a surface layer was applied onto the charge-transporting layer by dip coating so that its thickness at the time of completion became about 1 μm. Thus, a coat was formed. The resultant coat was subjected to heating treatment for 60 minutes at 130° C. Thus, an electrophotographic photosensitive member 1 was produced. The thickness of the surface layer of the photosensitive member was 1.1 m.

### <Electrophotographic Photosensitive Members 2 to 24>

In the production example of the electrophotographic photosensitive member 1, the process up to the production of the charge-transporting layer was similarly performed, and coating liquids 2 to 24 for surface layers to be used in the production of surface layers were prepared while materials therefor were changed as shown in Table 1-1 to 1-3. Electrophotographic photosensitive members 2 to 24 were produced by the same method as that of the electrophotographic photosensitive member 1 through use of the prepared coating liquids 2 to 24 for surface layers, respectively.

### <Production of Niobium-Doped Titanium Oxide>

Niobium sulfate (water-soluble niobium compound) was added to a hydrous titanium dioxide slurry obtained by hydrolyzing an aqueous solution of titanyl sulfate. An addition amount was as follows: niobium sulfate was added as a niobium ion at a ratio of 1.8 mass % with respect to the amount of titanium in the slurry (in terms of titanium dioxide).

The product obtained by adding niobium sulfate as a niobium ion at a ratio of 1.8 mass % to the aqueous solution of titanyl sulfate was hydrolyzed to provide a hydrous titanium dioxide slurry. Next, the hydrous titanium dioxide slurry containing a niobium ion or the like was dewatered, and was fired at a firing temperature of 1,000° C. Thus, anatase-type titanium oxide particles having an average primary particle diameter of 66 nm, the particles each containing 1.8 mass % of a niobium element, were obtained.

TABLE 1-1

| Kind of coating | Polyol 1 | | Polyol 2 | | Isocyanate | |
|---|---|---|---|---|---|---|
| liquid for surface | Product | Part(s) by | Product | Part(s) by | Product | Part(s) by |
| layer | name | mass | name | mass | name | mass |
| Coating liquid 1 | DC2016 | 17.8 | — | — | BI 7951 | 22.2 |
| for surface layer | | | | | | |
| Coating liquid 2 | DC2016 | 17.8 | — | — | BI 7951 | 22.2 |
| for surface layer | | | | | | |
| Coating liquid 3 | DC2016 | 17.8 | — | — | BI 7951 | 22.2 |
| for surface layer | | | | | | |
| Coating liquid 4 | DC2016 | 17.8 | — | — | BI 7951 | 22.2 |
| for surface layer | | | | | | |
| Coating liquid 5 | DC2016 | 17.8 | — | — | BI 7951 | 22.2 |
| for surface layer | | | | | | |
| Coating liquid 6 | DC2016 | 17.8 | — | — | BI 7951 | 22.2 |
| for surface layer | | | | | | |
| Coating liquid 7 | DC2016 | 17.8 | — | — | BI 7951 | 22.2 |
| for surface layer | | | | | | |
| Coating liquid 8 | DC2016 | 17.8 | — | — | BI 7951 | 22.2 |
| for surface layer | | | | | | |
| Coating liquid 9 | DC2016 | 17.8 | — | — | BI 7951 | 22.2 |
| for surface layer | | | | | | |
| Coating liquid 10 | DC2016 | 17.8 | — | — | BI 7951 | 22.2 |
| for surface layer | | | | | | |
| Coating liquid 11 | DC2016 | 17.8 | — | — | BI 7951 | 22.2 |
| for surface layer | | | | | | |
| Coating liquid 12 | DC2016 | 16.5 | PTG- | 1.7 | BI 7951 | 21.9 |
| for surface layer | | | 1000SN | | | |
| Coating liquid 13 | DC2016 | 17.8 | — | — | BI 7951 | 22.2 |
| for surface layer | | | | | | |
| Coating liquid 14 | DC2016 | 17.8 | — | — | BI 7951 | 22.2 |
| for surface layer | | | | | | |
| Coating liquid 15 | DC2016 | 16.5 | PTG- | 1.7 | BI 7951 | 21.9 |
| for surface layer | | | 1000SN | | | |
| Coating liquid 16 | DC2016 | 15.9 | PTG- | 1.6 | BI 7951 | 22.5 |
| for surface layer | | | 2000SN | | | |
| Coating liquid 17 | DC2016 | 17.8 | — | — | BI 7951 | 22.2 |
| for surface layer | | | | | | |
| Coating liquid 18 | DC2016 | 17.8 | — | — | BI 7951 | 22.2 |
| for surface layer | | | | | | |
| Coating liquid 19 | DC2016 | 21.2 | — | — | BI 7982 | 18.8 |
| for surface layer | | | | | | |
| Coating liquid 20 | DC2016 | 21.2 | — | — | BI 7961 | 18.8 |
| for surface layer | | | | | | |
| Coating liquid 21 | DC2016 | 15.4 | PTG- | 1.54 | BI 7951 | 23.1 |
| for surface layer | | | 2900SN | | | |
| Coating liquid 22 | DC2016 | 17.8 | — | — | BI 7951 | 22.2 |
| for surface layer | | | | | | |
| Coating liquid 23 | DC2016 | 17.8 | — | — | BI 7951 | 22.2 |
| for surface layer | | | | | | |
| Coating liquid 24 | DC2016 | 17.8 | — | — | BI 7951 | 22.2 |
| for surface layer | | | | | | |

TABLE 1-2

| | Inorganic particles 1 | | | | Inorganic particles 2 | | | |
|---|---|---|---|---|---|---|---|---|
| Kind of coating | | Particle | | | | Particle | | |
| liquid for surface | Product | diameter | Mohs | Part(s) by | Product | diameter | Mohs | Part(s) by |
| layer | name | [nm] | hardness | mass | name | [nm] | hardness | mass |
| Coating liquid 1 | QSG- | 170 | 7.0 | 17.4 | — | — | — | — |
| for surface layer | 170 | | | | | | | |
| Coating liquid 2 | KE-P50 | 500 | 7.0 | 130.3 | — | — | — | — |
| for surface layer | | | | | | | | |
| Coating liquid 3 | QSG- | 170 | 7.0 | 130.3 | — | — | — | — |
| for surface layer | 170 | | | | | | | |
| Coating liquid 4 | QSG-30 | 30 | 7.0 | 130.3 | — | — | — | — |
| for surface layer | | | | | | | | |
| Coating liquid 5 | KE-P50 | 500 | 7.0 | 17.4 | — | — | — | — |
| for surface layer | | | | | | | | |
| Coating liquid 6 | QSG-30 | 30 | 7.0 | 17.4 | — | — | — | — |
| for surface layer | | | | | | | | |
| Coating liquid 7 | KE-P50 | 500 | 7.0 | 4.3 | — | — | — | — |
| for surface layer | | | | | | | | |
| Coating liquid 8 | QSG- | 170 | 7.0 | 4.3 | — | — | — | — |
| for surface layer | 170 | | | | | | | |
| Coating liquid 9 | QSG-30 | 30 | 7.0 | 4.3 | — | — | — | — |
| for surface layer | | | | | | | | |
| Coating liquid 10 | QSG- | 170 | 7.0 | 4.3 | — | — | — | — |
| for surface layer | 170 | | | | | | | |
| Coating liquid 11 | QSG- | 170 | 7.0 | 21.7 | QSG-30 | 30 | 7.0 | 21.7 |
| for surface layer | 170 | | | | | | | |
| Coating liquid 12 | QSG-30 | 30 | 7.0 | 4.5 | — | — | — | — |
| for surface layer | | | | | | | | |
| Coating liquid 13 | MgO | <=50 | 4.0 | 35.2 | — | — | — | — |
| for surface layer | | | | | | | | |
| Coating liquid 14 | Al₂O₃ | <50 | 9.0 | 36.7 | — | — | — | — |
| for surface layer | | | | | | | | |
| Coating liquid 15 | QSG- | 170 | 7.0 | 17.9 | — | — | — | — |
| for surface layer | 170 | | | | | | | |
| Coating liquid 16 | QSG- | 170 | 7.0 | 17.9 | — | — | — | — |
| for surface layer | 170 | | | | | | | |
| Coating liquid 17 | (Note 1) | 66 | 5.7 | 38.6 | — | — | — | — |
| for surface layer | | | | | | | | |
| Coating liquid 18 | QSG- | 170 | 7.0 | 17.4 | — | — | — | — |
| for surface layer | 170 | | | | | | | |
| Coating liquid 19 | QSG- | 170 | 7.0 | 17.9 | — | — | — | — |
| for surface layer | 170 | | | | | | | |
| Coating liquid 20 | QSG- | 170 | 7.0 | 17.9 | — | — | — | — |
| for surface layer | 170 | | | | | | | |
| Coating liquid 21 | QSG- | 170 | 7.0 | 17.9 | — | — | — | — |
| for surface layer | 170 | | | | | | | |
| Coating liquid 22 | QSG- | 170 | 7.0 | 43.4 | — | — | — | — |
| for surface layer | 170 | | | | | | | |
| Coating liquid 23 | QSG- | 170 | 7.0 | 130.3 | — | — | — | — |
| for surface layer | 170 | | | | | | | |
| Coating liquid 24 | MT- | 80 | 5.7 | 38.6 | — | — | — | — |
| for surface layer | 700Z | | | | | | | |

TABLE 1-3

| | | | | | | | | | Volume ratio of |
|---|---|---|---|---|---|---|---|---|---|
| Kind of coating | Additive 1 | | Additive 2 | | Solvent 1 | | Solvent 2 | | inorganic |
| liquid for surface | Product | Part(s) | Product | Part(s) | Product | Part(s) | Product | Part(s) | particles to |
| layer | name | by mass | name | by mass | name | by mass | name | by mass | binder resin |
| Coating liquid 1 | US270 | 5.4 | — | — | Cyclohexane | 100 | 1-Propanol | 100 | 0.40 |
| for surface layer | | | | | | | | | |
| Coating liquid 2 | US270 | 5.4 | — | — | Cyclohexane | 100 | 1-Propanol | 100 | 3.0 |
| for surface layer | | | | | | | | | |
| Coating liquid 3 | US270 | 5.4 | — | — | Cyclohexane | 100 | 1-Propanol | 100 | 3.0 |
| for surface layer | | | | | | | | | |
| Coating liquid 4 | US270 | 5.4 | — | — | Cyclohexane | 100 | 1-Propanol | 100 | 3.0 |
| for surface layer | | | | | | | | | |
| Coating liquid 5 | US270 | 5.4 | — | — | Cyclohexane | 100 | 1-Propanol | 100 | 0.40 |
| for surface layer | | | | | | | | | |
| Coating liquid 6 | US270 | 5.4 | — | — | Cyclohexane | 100 | 1-Propanol | 100 | 0.40 |
| for surface layer | | | | | | | | | |
| Coating liquid 7 | US270 | 5.4 | — | — | Cyclohexane | 100 | 1-Propanol | 100 | 0.10 |
| for surface layer | | | | | | | | | |
| Coating liquid 8 | US270 | 5.4 | — | — | Cyclohexane | 100 | 1-Propanol | 100 | 0.10 |
| for surface layer | | | | | | | | | |
| Coating liquid 9 | US270 | 5.4 | — | — | Cyclohexane | 100 | 1-Propanol | 100 | 0.10 |
| for surface layer | | | | | | | | | |
| Coating liquid 10 | US270 | 5.4 | — | — | Cyclohexane | 100 | 1-Propanol | 100 | 1.0 |
| for surface layer | | | | | | | | | |
| Coating liquid 11 | US270 | 5.4 | — | — | Cyclohexane | 100 | 1-Propanol | 100 | 1.0 |
| for surface layer | | | | | | | | | |
| Coating liquid 12 | US270 | 5.5 | KAOLIZER | 4.0 | Cyclohexane | 100 | 1-Propanol | 100 | 0.10 |
| for surface layer | | | No. 25 | | | | | | |
| Coating liquid 13 | US270 | 5.4 | — | — | Cyclohexane | 100 | 1-Propanol | 100 | 0.40 |
| for surface layer | | | | | | | | | |
| Coating liquid 14 | US270 | 5.4 | — | — | Cyclohexane | 100 | 1-Propanol | 100 | 0.40 |
| for surface layer | | | | | | | | | |
| Coating liquid 15 | US270 | 5.5 | KAOLIZER | 4.0 | Cyclohexane | 100 | 1-Propanol | 100 | 0.40 |
| for surface layer | | | No. 25 | | | | | | |
| Coating liquid 16 | US270 | 5.5 | KAOLIZER | 4.0 | Cyclohexane | 100 | 1-Propanol | 100 | 0.40 |
| for surface layer | | | No. 25 | | | | | | |
| Coating liquid 17 | US270 | 5.4 | — | — | Cyclohexane | 100 | 1-Propanol | 100 | 0.40 |
| for surface layer | | | | | | | | | |
| Coating liquid 18 | US270 | 5.4 | (C-1) | 2.0 | Cyclohexane | 100 | 1-Propanol | 100 | 0.40 |
| for surface layer | | | | | | | | | |
| Coating liquid 19 | US270 | 5.6 | — | — | Cyclohexane | 100 | 1-Propanol | 100 | 0.40 |
| for surface layer | | | | | | | | | |
| Coating liquid 20 | US270 | 5.6 | — | — | Cyclohexane | 100 | 1-Propanol | 100 | 0.40 |
| for surface layer | | | | | | | | | |
| Coating liquid 21 | US270 | 5.5 | KAOLIZER | 4.0 | Cyclohexane | 100 | 1-Propanol | 100 | 0.40 |
| for surface layer | | | No. 25 | | | | | | |
| Coating liquid 22 | US270 | 5.4 | — | — | Cyclohexane | 100 | 1-Propanol | 100 | 1.0 |
| for surface layer | | | | | | | | | |
| Coating liquid 23 | US270 | 5.4 | — | — | Cyclohexane | 100 | 1-Propanol | 100 | 3.0 |
| for surface layer | | | | | | | | | |
| Coating liquid 24 | US270 | 5.4 | — | — | Cyclohexane | 100 | 1-Propanol | 100 | 0.40 |
| for surface layer | | | | | | | | | |

(Note 1)
the niobium-doped titanium oxide described in Examples

The materials used in the production of the coating liquids for surface layers are described below.

### Polyol

PTG-1000SN (manufacturer: Hodogaya Chemical Co., Ltd.)
PTG-2000SN (manufacturer: Hodogaya Chemical Co., Ltd.)
PTG-2900SN (manufacturer: Hodogaya Chemical Co., Ltd.)

### Isocyanate

B1 7982 (manufacturer: GSI Creos Corporation)
B1 7961 (manufacturer: GSI Creos Corporation)
   Inorganic particles
KE-P50 (manufacturer: NIPPON SHOKUBAI CO., LTD., silica particles)
QSG-30 (manufacturer: Shin-Etsu Chemical Co., Ltd., silica particles)
MgO (manufacturer: Sigma-Aldrich Japan K.K.)
Al₂O₃ (manufacturer: Sigma-Aldrich Japan K.K.)
MT-700Z (manufacturer: TAYCA CORPORATION, titanium oxide)

### Additive

KAOLIZER No. 25 (manufacturer: Kao Corporation)

For the densities of the particles, reference may be made to values published in the manufacturers of the respective materials and the database “POLYINFO” of National Institute for Materials Science. The following values were used as the densities of the various materials.
PTG-1000SN, PTG-2000SN, and PTG-2900SN: density: 0.98 g/cm³
B1 7951, BI 7961, and BI 7982: density: 1.05 g/cm³
Silica particles: density: 1.8 g/cm³
Magnesium oxide: density: 3.65 g/cm³
Aluminum oxide: density: 3.65 g/cm³
Titanium oxide: density: 4.0 g/cm³

### Comparative Examples

In the production example of the electrophotographic photosensitive member 1, the process up to the production of the charge-transporting layer was similarly performed, and coating liquids c1 to c9 for surface layers to be used in the production of surface layers were prepared while materials therefor were changed as shown in Table 2-1 to 2-3. Electrophotographic photosensitive members c1 to c9 were produced by the same method as that of the electrophotographic photosensitive member 1 through use of the prepared coating liquids c1 to c9 for surface layers, respectively.

TABLE 2-1

| | Polyol 1 | | Polyol 2 | | Isocyanate | |
|---|---|---|---|---|---|---|
| Kind of coating liquid for | Product | Part(s) | Product | Part(s) | Product | Part(s) by |
| surface layer | name | by mass | name | by mass | name | mass |
| Coating liquid c1 for | DC2016 | 17.8 | — | — | BI 7951 | 22.2 |
| surface layer | | | | | | |
| Coating liquid c2 for | DC2016 | 17.8 | — | — | BI 7951 | 22.2 |
| surface layer | | | | | | |
| Coating liquid c3 for | DC2016 | 17.8 | — | — | BI 7951 | 22.2 |
| surface layer | | | | | | |
| Coating liquid c4 for | DC2016 | 17.8 | — | — | BI 7951 | 22.2 |
| surface layer | | | | | | |
| Coating liquid c5 for | DC2016 | 17.8 | — | — | BI 7951 | 22.2 |
| surface layer | | | | | | |
| Coating liquid c6 for | DC2016 | 17.8 | — | — | BI 7951 | 22.2 |
| surface layer | | | | | | |
| Coating liquid c7 for | DC2016 | 17.8 | — | — | BI 7951 | 22.2 |
| surface layer | | | | | | |
| Coating liquid c8 for | DC2016 | 17.8 | — | — | BI 7951 | 22.2 |
| surface layer | | | | | | |
| Coating liquid c9 for | Trisphenol | 2.8 | — | — | TAKENATE | 4.2 |
| surface layer | | | | | D140N | |

TABLE 2-2

| | Inorganic particles 1 | | | | Inorganic particles 2 | | | |
|---|---|---|---|---|---|---|---|---|
| Kind of coating | | Particle | | | | Particle | | |
| liquid for surface | Product | diameter | Mohs | Part(s) | Product | diameter | Mohs | Part(s) |
| layer | name | [nm] | hardness | by mass | name | [nm] | hardness | by mass |
| Coating liquid c1 | KE-P50 | 500 | 7.0 | 146.7 | — | — | — | — |
| for surface layer | | | | | | | | |
| Coating liquid c2 | QSG-30 | 30 | 7.0 | 139.0 | — | — | — | — |
| for surface layer | | | | | | | | |
| Coating liquid c3 | KE-P100 | 1,000 | 7.0 | 137.5 | — | — | — | — |
| for surface layer | | | | | | | | |
| Coating liquid c4 | QSG-10 | 15 | 7.0 | 130.3 | — | — | — | — |
| for surface layer | | | | | | | | |
| Coating liquid c5 | KE-P100 | 1,000 | 7.0 | 4.6 | — | — | — | — |
| for surface layer | | | | | | | | |
| Coating liquid c6 | QSG-10 | 15 | 7.0 | 4.3 | — | — | — | — |
| for surface layer | | | | | | | | |
| Coating liquid c7 | KE-P50 | 500 | 7.0 | 3.2 | — | — | — | — |
| for surface layer | | | | | | | | |
| Coating liquid c8 | QSG-30 | 30 | 7.0 | 3.0 | — | — | — | — |
| for surface layer | | | | | | | | |
| Coating liquid c9 | NanoTek | 20 | 9.0 | 3.0 | — | — | — | — |
| for surface layer | Al₂O₃ | | | | | | | |

TABLE 2-3

| | | | | | | | | | Volume ratio |
|---|---|---|---|---|---|---|---|---|---|
| Kind of coating | Additive 1 | | Additive 2 | | Solvent 1 | | Solvent 2 | | of inorganic |
| liquid for | Product | Part(s) | Product | Part(s) | Product | Part(s) | Product | Part(s) | particles to |
| surface layer | name | by mass | name | by mass | name | by mass | name | by mass | binder resin |
| Coating liquid c1 | US270 | 5.4 | — | — | Cyclohexane | 100 | 1-Propanol | 100 | 3.2 |
| for surface layer | | | | | | | | | |
| Coating liquid c2 | US270 | 5.4 | — | — | Cyclohexane | 100 | 1-Propanol | 100 | 3.2 |
| for surface layer | | | | | | | | | |
| Coating liquid c3 | US270 | 5.4 | — | — | Cyclohexane | 100 | 1-Propanol | 100 | 3.0 |
| for surface layer | | | | | | | | | |
| Coating liquid c4 | US270 | 5.4 | — | — | Cyclohexane | 100 | 1-Propanol | 100 | 3.0 |
| for surface layer | | | | | | | | | |
| Coating liquid c5 | US270 | 5.4 | — | — | Cyclohexane | 100 | 1-Propanol | 100 | 0.10 |
| for surface layer | | | | | | | | | |
| Coating liquid c6 | US270 | 5.4 | — | — | Cyclohexane | 100 | 1-Propanol | 100 | 0.10 |
| for surface layer | | | | | | | | | |
| Coating liquid c7 | US270 | 5.4 | — | — | Cyclohexane | 100 | 1-Propanol | 100 | 0.070 |
| for surface layer | | | | | | | | | |
| Coating liquid c8 | US270 | 5.4 | — | — | Cyclohexane | 100 | 1-Propanol | 100 | 0.070 |
| for surface layer | | | | | | | | | |
| Coating liquid c9 | Cellosolve | 20.0 | — | — | Acetone | 60 | MIBK | 10 | 0.13 |
| for surface layer | acetate | | | | | | | | |

NanoTek Al₂O₃ (manufacturer: C.I. Kasei Co., Ltd.)
Trisphenol (manufacturer: Chuo Kaseihin Co., Inc.)
KE-P100 (manufacturer: NTPPON SHOKUBAI CO., LTD., silica particles)
Takenate D140N (manufacturer: Mitsui Takeda Chemicals, Inc.)

### <Evaluation Approach>

### <Derivation of Ratio of Volume of Inorganic Particles to Volume of Binder Resin in Surface Layer>

The ratio of the volume of inorganic particles to the volume of a binder resin in a surface layer was calculated from the numbers of parts of an acrylic monomer and the inorganic particles to be used in a coating liquid for a surface layer. For the specific gravities of the acrylic monomer and the inorganic particles, reference may be made to values published in the manufacturers of the respective materials.

When the ratio is determined from an electrophotographic photosensitive member, for example, the following method is available.

A plurality of sections are peeled only from the surface layer of the electrophotographic photosensitive member with a cutting tool, and the sections are each subjected to composition analysis, such as NMR, ESI-MS, or LC-CAD/MS/MSn, so that a polymerizable monomer having a polymerizable functional group, the monomer forming a composition before the binder resin in the surface layer becomes a polymer, may be identified.

In addition, another section is subjected to thermogravimetric analysis such as TGA so that the masses of the binder resin and the inorganic particles incorporated into the surface layer may be measured.

Further, sintered inorganic particles are subjected to composition analysis, such as SEM-EDS or XRF, so that a material for the inorganic particles may be identified, followed by the determination of its specific gravity.

In the electrophotographic photosensitive member including the surface layer containing the binder resin and the inorganic particles, the value of the ratio of the volume of the inorganic particles to the volume of the binder resin in the surface layer is calculated by such approach.

### <Evaluation of Protrusions of Surface Layer of Electrophotographic Photosensitive Member>

Protrusions formed on the surface of the surface layer of the electrophotographic photosensitive member may be evaluated by observing the surface of the electrophotographic photosensitive member with an electron microscope. When a more detailed evaluation is performed, the observation of the sections of the protrusions of the surface layer of the electrophotographic photosensitive member is suitable. For example, the following method is available.

A 5-millimeter square sample piece was cut out of the electrophotographic photosensitive member with a tool such as a saw. At this time, a total of twelve 5-millimeter square sample pieces were cut out of positions determined as follows: positions distant from an end portion of the photosensitive member by 38 mm, 128 mm, and 218 mm in the longitudinal direction thereof were determined, and four points were determined every 900 in the peripheral direction thereof at each of the distances. Each of the sample pieces was fixed to a sample holder so that its surface layer was able to be observed. The sample holder having fixed thereto the sample piece was subjected to sectional observation with a FIB-SEM (product name: NVision, manufacturer: Carl Zeiss AG).

Conditions for the measurement with the FIB-SEM are as described below.

A region measuring 2 μm by 2 μm by 2 μm in the surface layer was three-dimensionalized by the “Slice & View” of the FIB-SEM.

Conditions for the “Slice & View” were set as described below.
Processing of sample for analysis: FIB method
Processing and observation device: NVision 40 manufactured by SII/Zeiss
Slice interval: 10 nm

### (Observation Conditions)

Acceleration voltage: 1.0 kV
Sample tilt: 540
WD: 5 mm
Detector: BSE detector
Aperture: 60 μm, high current
ABC: ON
Image resolution: 1.25 nm/pixel

In addition, a measurement environment has a temperature of 23° C. and a pressure of 1×10⁻⁴ Pa. Strata 400S manufactured by FEI (sample tilt: 52°) may also be used as the processing and observation device.

The protrusions of the surface layer of the electrophotographic photosensitive member were evaluated in the sectional image of the surface layer obtained with the FIB-SEM. The operation was performed on all the protrusions that were present in the sectional image and whose whole aspects fell within the sectional image. The same operation was performed on each of the twelve sample pieces, and when 90% of the evaluated protrusions were protrusions derived from the inorganic particles, it was judged that the protrusions of the surface layer of the electrophotographic photosensitive member were protrusions derived from the inorganic particles.

<Evaluation of Number-Based Average Primary Particle Diameter of Inorganic Particles to be Incorporated into Surface Layer>

For the number-based average primary particle diameter of the inorganic particles to be incorporated into the surface layer, reference may be made to values published in the manufacturers of the respective materials for the inorganic particles to be used. When the average primary particle diameter is evaluated from the electrophotographic photosensitive member, for example, the following method is available.

First, the electrophotographic photosensitive member was entirely immersed in methyl ethyl ketone (MEK) in a graduated cylinder and irradiated with an ultrasonic wave to peel off resin layers, and then the substrate of the electrophotographic photosensitive member was taken out. Next, insoluble matter that did not dissolve in MEK (the photosensitive layer and the protective layer containing the metal oxide particles) was filtered, and was brought to dryness with a vacuum dryer. Further, the resultant solid was suspended in a mixed solvent of tetrahydrofuran (THF) and methylal at a volume ratio of 1:1, insoluble matter was filtered, and then the filtration residue was recovered and brought to dryness with a vacuum dryer. Through this operation, the inorganic particles and the resin of the surface layer were obtained. Further, the filtration residue was heated in an electric furnace to 500° C. so as to leave only the inorganic particles as solids, and the inorganic particles were collected. To secure an amount of the inorganic particles required for measurement, a plurality of electrophotographic photosensitive members were similarly treated.

Part of the collected inorganic particles were dispersed in isopropanol (IPA), and the dispersion liquid was dropped onto a grid mesh with a support membrane (product name: Cu150J, manufacturer: JEOL Ltd.), followed by the observation of the inorganic particles in the STEM mode of a scanning transmission electron microscope (product name: JEM2800, manufacturer: JEOL Ltd.). The observation was performed at a magnification of from 500,000 to 1,200,000 so as to facilitate the calculation of the particle diameters of the inorganic particles, and STEM images of 100 inorganic particles each were taken. The inorganic particles were distinguished by using the EDX function of the scanning transmission electron microscope. At this time, the following settings were adopted: an acceleration voltage of 200 kV, a probe size of 1 nm, and an image size of 1,024×1,024 pixels.

Through use of the resultant STEM images, a primary particle diameter was measured with image processing software “Image-Pro Plus (manufacturer: Media Cybernetics, Inc.)”. First, a scale bar displayed in the lower portion of the STEM image is selected through use of the straight line tool (Straight Line) of the tool bar. When the “Set Scale” of the “Analyze” menu is selected under the state, a new window is opened, and the pixel distance of a selected straight line is input in the “Distance in Pixels” column. The value (e.g., 100) of the scale bar is input in the “Known Distance” column of the window, and the unit (e.g., nm) of the scale bar is input in the “Unit of Measurement” column, followed by the clicking of OK. Thus, scale setting is completed. Next, a straight line was drawn so as to coincide with the maximum diameter of an inorganic particle through use of the straight line tool, and the particle diameter was calculated. The same operation was performed for 100 inorganic particles, and the number average of the resultant values (maximum diameters) was defined as the primary particle diameter of the inorganic particles.

However, with regard to a sample using carbon black or the like as its inorganic particles, the average primary particle diameter of the particles was measured by the following method.

A 5-millimeter square sample piece was cut out of the electrophotographic photosensitive member with a tool such as a saw. At this time, a total of twelve 5-millimeter square sample pieces were cut out of positions determined as follows: positions distant from an end portion of the photosensitive member by 38 mm, 128 mm, and 218 mm in the longitudinal direction thereof were determined, and four points were determined every 900 in the peripheral direction thereof at each of the distances. Each of the sample pieces was fixed to a sample holder so that its surface layer was able to be observed. The sample holder having fixed thereto the sample piece was subjected to sectional observation with a FIB-SEM (product name: NVision, manufacturer: Carl Zeiss AG). Conditions for the measurement are the same as those described above.

In the sectional image of the surface layer of the electrophotographic photosensitive member obtained with the FIB-SEM, the particle diameters of the particles were measured. The operation was performed on all the particles that were present in the sectional image and whose whole aspects fell within the sectional image. The arithmetic average value of the particle diameters of the particles thus obtained was defined as the average particle diameter of the sample piece, and a value obtained by further arithmetically averaging the average particle diameters of the respective twelve sample pieces was defined as the average primary particle diameter of the particles to be incorporated into the surface layer of the electrophotographic photosensitive member.

### <Evaluations of Maximum Height Roughness Rz, Arithmetic Average Roughness Ra, and Average Length Rsm>

A 5-millimeter square sample piece was cut out of the electrophotographic photosensitive member with a tool such as a saw. At this time, a total of twelve 5-millimeter square sample pieces were cut out of positions determined as follows: positions distant from an end portion of the photosensitive member by 38 mm, 128 mm, and 218 mm in the longitudinal direction thereof were determined, and four points were determined every 900 in the peripheral direction thereof at each of the distances. Each of the sample pieces was fixed to a sample holder so that its surface layer was able to be observed. The sample holder having fixed thereto the sample piece is observed with a scanning probe microscope SPM. The observation was performed on each of the twelve sample pieces, and the arithmetic average of the maximum height roughnesses Rz of these samples was defined as the maximum height roughness Rz of the electrophotographic photosensitive member. The arithmetic average roughness Ra and average length Rsm of each of the samples were measured by the same method as that of the maximum height roughness Rz, and the arithmetic averages of the twelve sample pieces were defined as the arithmetic average roughness Ra and average length Rsm of the electrophotographic photosensitive member. A scanning probe microscope “JSPM-5200” (manufacturer: JEOL Ltd.), a scanning probe microscope “E-sweep” (manufacturer: Hitachi High-Tech Corporation), a medium-sized probe microscope system “AFM 5500M” (manufacturer: Hitachi High-Tech Corporation), or the like may be used as the SPM. Conditions for observation with each of the “JSPM-5200” and the “E-sweep” are described below as a specific measurement method. In this specification, the observation was performed with the JSPM-5200. The results of the measurement are shown in Table 3 and Table 4.

Observation with “JSPM-5200”
Scanner: 4
SPM Scan: All SPM Mode
Cantilever: SI-DF3P2 (manufacturer: Hitachi High-Tech Fielding Corporation) Resonance Frequency Detection: (START) 1.00 kHz, (STOP) 100 kHz (in the case of f=67 kHz, depending on the kind of cantilever)
Cantilever Autotune: Normal approach
Acquisition: 2 Inputs (512)
Scan Mode: Normal
STM/AFM: AC-AFM
Clock: 833.33 s
Scan Size: 3.00 nm
Offset: 0
Bias [V]: 0
Reference/V: unchanged (calibrated value is input)
Filter: 1.4 Hz
Loop Gain: 16

The data image of the surface shape of the surface layer was analyzed with Win SPM Processing attached to the JSPM-5200 through use of a mode for the analysis of surface roughness. The average value of the maximum height roughnesses Rz that were each a difference between the maximum value Zmax and minimum value Zmin of the height “z” of each of the above-mentioned samples was determined, and the average value of the arithmetic average roughnesses Ra of the samples and the average value of the average lengths Rsm of the roughness curve elements thereof were also determined.

In addition, a measurement method including using a scanning probe microscope “E-sweep” (manufacturer: Hitachi High-Tech Corporation) is as described below. The measurement was performed through a scanning operation to output the analyzed image of data on the surface shape.

Observation with “E-Sweep”
Cantilever: SI-DF20 (with a back-surface AL) K-A102002771 (manufacturer: Hitachi High-Tech Fielding Corporation)
Scanning probe microscope: manufactured by Hitachi High-Tech Science Corporation
Measuring unit: E-sweep
Measurement mode: DFM (resonance mode) shape image
Resolution: number of pieces of X data: 512, number of pieces of Y data: 512
Measurement frequency: 127 Hz

A Q-curve measurement magnification, an exciting voltage, a low-pass filter, a high-pass filter, and the like were adjusted so that the resonance state of the cantilever was able to be optimized.

The image of the surface shape and surface height data attached to the image were analyzed with software attached to the E-sweep, followed by the determination of the average value of the maximum height roughnesses Rz that were each a difference between the maximum value Zmax and minimum value Zmin of the height “z” of each of the samples, the average value of the arithmetic average roughnesses Ra of the samples, and the average value of the average lengths Rsm of the roughness curve elements thereof.

### <Evaluation of Dynamic Friction Coefficient>

A surface property-measuring machine (model: 14FW, manufacturer: Shinto Scientific Co., Ltd.) was used in the evaluation of the dynamic friction coefficient of the electrophotographic photosensitive member, and the evaluation was performed under a normal-temperature and normal-humidity environment (25° C., 50% RH; hereinafter also referred to as “N/N”). The electrophotographic photosensitive member was attached to the surface property-measuring machine so as to be horizontal, and a urethane piece perpendicularly cut into a 2-millimeter thick shape 10.0 mm on a side was brought into abutment with the electrophotographic photosensitive member at an angle of 22.5°. A trial production example of the urethane piece is described later. As the abutting pressure of the urethane piece, the electrophotographic photosensitive member was moved in its longitudinal direction at a speed of 100 mm/min while a dead weight of 10 g was mounted thereon. Thus, a frictional force was measured. The same frictional force measurement was performed except that the weight of the dead weight was changed to 20 g or 50 g. The dynamic friction coefficient was calculated from a relationship between the frictional force obtained by the frictional force measurement and the abutting pressure, and the value was defined as the dynamic friction coefficient of the electrophotographic photosensitive member. The results of the measurement are shown in Table 3 and Table 4.

A method for the trial production of the urethane piece is described below.

27.7 Parts by mass of 4,4′-diphenylmethane diisocyanate (product name: MILLIONATE MT, manufacturer: Tosoh Corporation) and 52.7 parts by mass of a polybutylene adipate polyester polyol having a molecular weight of 2.0×10³ (product name: NIPPOLAN 4010, manufacturer: Nippon Polyurethane Industry Co., Ltd.) were caused to react with each other under a nitrogen atmosphere at 80° C. for 3 hours to provide a prepolymer having an NCO content of 8.8%. In addition, 14.9 parts by mass of a PBA having a molecular weight of 1,000 (product name: NIPPOLAN 4009, manufacturer: Nippon Polyurethane Industry Co., Ltd.), 2.6 parts by mass of 1,4-butanediol (manufacturer: Tokyo Chemical Industry Co., Ltd.), 2.1 parts by mass of trimethylolpropane (manufacturer: Tokyo Chemical Industry Co., Ltd.), and 80 ppm of an isocyanuration catalyst (product name: P15, manufacturer: Air Products Japan K.K.) and 340 ppm of a urethanization catalyst (product name: DABCO crystal, manufacturer: Air Products Japan K.K.) each serving as a catalyst for curing were mixed. Thus, a curing agent was prepared.

The prepolymer and the curing agent were mixed, and the mixture was stirred for 70 seconds while deaeration was performed. The mixed liquid obtained by the stirring was poured into a mold warmed to 135° C., and was pressurized with a vise. At this time, an aluminum-made split mold in which a 2-millimeter thick square sheet 200 mm on a side was molded was used as the mold. Under a state in which the mixed liquid was pressurized with the vise, the mixed liquid was left at rest for 90 seconds while being warmed to 135° C. After that, a urethane resin sheet molded into a 2-millimeter thick square sheet 200 mm on a side was removed from the mold.

The hardness of the resultant urethane resin sheet was measured with a Wallace microhardness meter (manufacturer: H.W. Wallace & Co Limited) based on JIS K 6253. The measurement was performed at nine points serving as points of intersection of positions distant from a horizontal side of the urethane resin sheet by 50 mm, 100 mm, and 150 mm, and positions distant from a vertical side thereof by 50 mm, 100 mm, and 150 mm, and the average value of the measured values was defined as the hardness of the urethane resin sheet.

The hardness obtained at this time was 68 (IRID®).

The urethane resin sheet was perpendicularly cut so as to be a square sheet 10.0 mm on a side. Thus, the urethane piece perpendicularly cut into a 2-millimeter thick shape 10.0 mm on a side was obtained.

### <Horizontal Streak Evaluation>

To evaluate a horizontal streak image due to the slipping of the electrophotographic photosensitive member, the evaluation was performed with an electrophotographic apparatus (product name: i-SENSYS MF754Cdw, manufacturer: Canon Inc.) in a N/N environment. The image forming apparatus was reconstructed so that the conveying speed of a recording material, the peripheral speed of an intermediate transfer member, and the peripheral speed of the electrophotographic photosensitive member were able to be adjusted.

The image forming apparatus, a toner cartridge to be used in the image forming apparatus, the electrophotographic photosensitive member, and a letter-size recording material (product name: XEROX Vitality, manufacturer: Xerox Corporation, basis weight: 75 g/m²) were left to stand in the N/N environment for 24 hours. After that, the electrophotographic photosensitive member was attached to the toner cartridge, and the resultant was attached to the image forming apparatus.

The conveying speed of the recording material, the peripheral speed of the intermediate transfer member, and the peripheral speed of the electrophotographic photosensitive member were set to 300 mm/sec, 300 mm/sec, and 291 mm/sec, respectively. In other words, a difference between the peripheral speeds of the intermediate transfer member and the electrophotographic photosensitive member was set to 3%. The electrophotographic photosensitive members in all the toner cartridges for yellow, magenta, cyan, and black colors were identical to each other.

To output an evaluation image, as the initial stage of printing, first, a halftone image (toner laid-on level: 0.2 mg/cm²) in which margins each having a width of 5.0 mm were arranged on its upper, lower, left, and right sides was printed on one sheet of the recording material with cyan toner. After a full-color image having a print percentage of 1.0% had been printed on 50,000 sheets thereof, the same halftone image as that at the initial stage of the printing was printed as an evaluation image at the time of the long-term use of the apparatus on one sheet thereof. The halftone image was evaluated for a horizontal streak by the following criteria. A level equal to or higher than an evaluation criterion C is the level at which no disadvantage occurs in practical use. The results of the evaluation are shown in Table 3 and Table 4.

### (Evaluation Criteria)

A: No horizontal streak is observed by observation with a loupe.

B: No horizontal streak is observed by visual observation, but a horizontal streak is slightly observed by observation with a loupe.

C: A horizontal streak is slightly observed by visual observation.

D: A horizontal streak is observed by visual observation.

TABLE 3

| | | Protrusions derived | | | | | Dynamic | |
|---|---|---|---|---|---|---|---|---|
| | Kind of electrophotographic | from inorganic | Thickness | Rz | Rsm | Ra | friction | Image |
| Example | photosensitive member | particles | [μm] | [nm] | [nm] | [nm] | coefficient | rank |
| 1 | Electrophotographic | Present | 1.1 | 81 | 314 | 74 | 0.71 | A |
| | photosensitive member 1 | | | | | | | |
| 2 | Electrophotographic | Present | 1.0 | 758 | 1,384 | 497 | 0.82 | B |
| | photosensitive member 2 | | | | | | | |
| 3 | Electrophotographic | Present | 1.1 | 82 | 182 | 25 | 0.72 | B |
| | photosensitive member 3 | | | | | | | |
| 4 | Electrophotographic | Present | 1.0 | 23 | 47 | 12 | 0.90 | B |
| | photosensitive member 4 | | | | | | | |
| 5 | Electrophotographic | Present | 1.0 | 746 | 1,289 | 455 | 0.82 | B |
| | photosensitive member 5 | | | | | | | |
| 6 | Electrophotographic | Present | 1.1 | 19 | 233 | 13 | 0.91 | B |
| | photosensitive member 6 | | | | | | | |
| 7 | Electrophotographic | Present | 0.9 | 710 | 1,220 | 251 | 0.78 | B |
| | photosensitive member 7 | | | | | | | |
| 8 | Electrophotographic | Present | 0.9 | 67 | 525 | 55 | 0.71 | B |
| | photosensitive member 8 | | | | | | | |
| 9 | Electrophotographic | Present | 1.0 | 12 | 261 | 9 | 0.91 | B |
| | photosensitive member 9 | | | | | | | |
| 10 | Electrophotographic | Present | 1.0 | 78 | 177 | 72 | 0.72 | A |
| | photosensitive member 10 | | | | | | | |
| 11 | Electrophotographic | Present | 1.1 | 82 | 499 | 41 | 0.70 | B |
| | photosensitive member 11 | | | | | | | |
| 12 | Electrophotographic | Present | 1.2 | 13 | 268 | 13 | 0.95 | B |
| | photosensitive member 12 | | | | | | | |
| 13 | Electrophotographic | Present | 1.0 | 43 | 229 | 22 | 0.93 | B |
| | photosensitive member 13 | | | | | | | |
| 14 | Electrophotographic | Present | 1.1 | 46 | 230 | 24 | 0.85 | A |
| | photosensitive member 14 | | | | | | | |
| 15 | Electrophotographic | Present | 0.9 | 77 | 311 | 75 | 0.83 | A |
| | photosensitive member 15 | | | | | | | |
| 16 | Electrophotographic | Present | 1.0 | 85 | 315 | 74 | 0.91 | B |
| | photosensitive member 16 | | | | | | | |
| 17 | Electrophotographic | Present | 0.9 | 33 | 263 | 24 | 0.90 | A |
| | photosensitive member 17 | | | | | | | |
| 18 | Electrophotographic | Present | 1.1 | 78 | 310 | 69 | 0.71 | A |
| | photosensitive member 18 | | | | | | | |
| 19 | Electrophotographic | Present | 1.0 | 72 | 324 | 63 | 0.81 | A |
| | photosensitive member 19 | | | | | | | |
| 20 | Electrophotographic | Present | 1.0 | 60 | 305 | 55 | 2.52 | C |
| | photosensitive member 20 | | | | | | | |
| 21 | Electrophotographic | Present | 1.1 | 53 | 302 | 42 | 1.55 | C |
| | photosensitive member 21 | | | | | | | |
| 22 | Electrophotographic | Present | 1.9 | 40 | 264 | 33 | 0.84 | B |
| | photosensitive member 22 | | | | | | | |
| 23 | Electrophotographic | Present | 2.5 | 32 | 322 | 19 | 1.90 | C |
| | photosensitive member 23 | | | | | | | |
| 24 | Electrophotographic | Present | 0.9 | 29 | 267 | 25 | 0.92 | A |
| | photosensitive member 24 | | | | | | | |

TABLE 4

| | | Protrusions | | | | | | |
|---|---|---|---|---|---|---|---|---|
| | | derived from | | | | | Dynamic | |
| Comparative | Kind of electrophotographic | inorganic | Thickness | Rz | Rsm | Ra | friction | Image |
| Example | photosensitive member | particles | [μm] | [nm] | [nm] | [nm] | coefficient | rank |
| 1 | Electrophotographic | Present | 1.0 | 768 | 1,434 | 561 | 0.79 | D |
| | photosensitive member c1 | | | | | | | |
| 2 | Electrophotographic | Present | 1.1 | 30 | 56 | 15 | 0.88 | D |
| | photosensitive member c2 | | | | | | | |
| 3 | Electrophotographic | Present | 1.1 | 855 | 1,881 | 809 | 1.16 | D |
| | photosensitive member c3 | | | | | | | |
| 4 | Electrophotographic | Present | 0.9 | 8 | 15 | 7 | 1.32 | D |
| | photosensitive member c4 | | | | | | | |
| 5 | Electrophotographic | Present | 1.0 | 789 | 2,568 | 745 | 1.24 | D |
| | photosensitive member c5 | | | | | | | |
| 6 | Electrophotographic | Present | 1.0 | 6 | 277 | 6 | 1.95 | D |
| | photosensitive member c6 | | | | | | | |
| 7 | Electrophotographic | Present | 1.0 | 666 | 1,630 | 564 | 1.27 | D |
| | photosensitive member c7 | | | | | | | |
| 8 | Electrophotographic | Present | 1.1 | 9 | 268 | 6 | 2.12 | D |
| | photosensitive member c8 | | | | | | | |
| 9 | Electrophotographic | Present | 2.5 | 865 | 2,013 | 808 | 2.51 | D |
| | photosensitive member c9 | | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-216300, filed Dec. 21, 2023, No. 2024-160155, filed Sep. 17, 2024, and No. 2024-211674, filed Dec. 4, 2024, which are hereby incorporated by reference herein in their entirety.

What is claimed is:

1. An electrophotographic photosensitive member comprising a surface layer containing a binder resin and inorganic particles,
wherein the surface layer contains a urethane resin as the binder resin,
wherein a value of a ratio of a volume of the inorganic particles to a volume of the binder resin in the surface layer is 0.10 or more and 3.0 or less,
wherein protrusions derived from the inorganic particles are present on a surface of the surface layer,
wherein the inorganic particles have a number-based average primary particle diameter of 10 nm or more and 500 nm or less, and
wherein the surface of the surface layer has a maximum height roughness Rz of 10 nm or more and 760 nm or less.

2. The electrophotographic photosensitive member according to claim 1, wherein the maximum height roughness Rz of the surface layer is 40 nm or more and 760 nm or less.

3. The electrophotographic photosensitive member according to claim 1, wherein roughness curve elements of the surface layer have an average length Rsm of 20 nm or more and 1,400 nm or less.

4. The electrophotographic photosensitive member according to claim 1, wherein the surface layer has an arithmetic average roughness Ra of 10 nm or more and 500 nm or less.

5. The electrophotographic photosensitive member according to claim 1, wherein the surface layer has a dynamic friction coefficient of 0.95 or less in an environment at 25° C. and 50% RH.

6. The electrophotographic photosensitive member according to claim 1, wherein the inorganic particles each have a functional group having reactivity with an isocyanate group.

7. The electrophotographic photosensitive member according to claim 1, wherein the surface layer has an arithmetic average thickness of 2.0 μm or less.

8. The electrophotographic photosensitive member according to claim 1, wherein the inorganic particles each have a Mohs hardness of 4.0 or more.

9. The electrophotographic photosensitive member according to claim 1, wherein the inorganic particles are one of silica particles or metal oxide particles.

10. The electrophotographic photosensitive member according to claim 9, wherein the metal oxide particles are each niobium atom-doped titanium oxide.

11. The electrophotographic photosensitive member according to claim 1, wherein the urethane resin has a nurate structure.

12. The electrophotographic photosensitive member according to claim 1, wherein the urethane resin is a polymer of an isocyanate compound having three or more polymerizable functional groups and a polyol compound.

13. The electrophotographic photosensitive member according to claim 1, wherein the urethane resin is a polymer of an isocyanate compound having a nurate structure and a polyol compound.

14. The electrophotographic photosensitive member according to claim 1, wherein the urethane resin is a polymer of an isocyanate compound and a polyol compound having an average molecular weight of 2.0×10³ or less.

15. A process cartridge comprising:
at least one unit selected from the group consisting of: a charging unit; a developing unit; and a cleaning unit,
the process cartridge integrally supporting the at least one unit and being detachably attachable onto a main body of an electrophotographic apparatus,
wherein the process cartridge comprises an electrophotographic photosensitive member,
wherein the electrophotographic photosensitive member includes a surface layer containing a binder resin and inorganic particles,
wherein the surface layer contains a urethane resin as the binder resin,
wherein a value of a ratio of a volume of the inorganic particles to a volume of the binder resin in the surface layer is 0.10 or more and 3.0 or less,
wherein protrusions derived from the inorganic particles are present on a surface of the surface layer,
wherein the inorganic particles have a number-based average primary particle diameter of 10 nm or more and 500 nm or less, and
wherein the surface of the surface layer has a maximum height roughness Rz of 10 nm or more and 760 nm or less.

16. An electrophotographic apparatus comprising:
an electrophotographic photosensitive member;
a charging unit;
an exposing unit;
a developing unit; and
a transfer unit,
wherein the electrophotographic photosensitive member includes a surface layer containing a binder resin and inorganic particles,
wherein the surface layer contains a urethane resin as the binder resin,
wherein a value of a ratio of a volume of the inorganic particles to a volume of the binder resin in the surface layer is 0.10 or more and 3.0 or less,
wherein protrusions derived from the inorganic particles are present on a surface of the surface layer,
wherein the inorganic particles have a number-based average primary particle diameter of 10 nm or more and 500 nm or less, and
wherein the surface of the surface layer has a maximum height roughness Rz of 10 nm or more and 760 nm or less.
